(19) United States
(12) Patent Application Publication
(10) Pub. No.: US 2021/0095075 A1
(43) Pub. Date: Apr. 1, 2021

(54) LAMELLAR STRUCTURE

(71) Applicant: NewSouth Innovations Pty Limited, Sydney, New South Wales (AU)

(72) Inventors: Da-Wei Wang, Allawah, New South Wales (AU); Kefeng Xiao, Kensington, New South Wales (AU)

(21) Appl. No.: 16/630,025

(22) PCT Filed: Jul. 13, 2018
(86) PCT No.: PCT/AU2018/050731

§ 371 Date: Jan. 10, 2020

(30) Foreign Application Priority Data
Jul. 14, 2017 (AU) 2017902774

(51) Int. Cl. C08G 73/02; C08K 3/22; H01G 11/48; H01G 11/46; H01G 11/50; H01G 11/86; H01B 1/12

(52) U.S. Cl. CPC C08G 73/0266; C08K 3/22; H01G 11/48; H01G 11/46; C08K 2003/2258; H01G 11/86; H01B 1/128; C08K 2003/2255; H01G 11/50

(57) ABSTRACT

Disclosed is an electrically conductive or semi-conductive lamellar structure, its method of production and use. The lamellar structure has a plurality of sheets, wherein each sheet comprises nanochains. At least some of the nanochains are electrically conductive or semi-conductive, and crosslinking agents connect adjacent nanochains.

### TECHNICAL FIELD

The present invention relates to lamellar structures, methods for preparing lamellar structures, and uses of lamellar structures. The electrically conductive lamellar structures of the present invention are useful in energy storage devices.

### BACKGROUND

Supercapacitors and batteries are appealing energy storage devices because of the fast charging-discharging capability, good safety and great life span. Next-generation energy storage devices with high performance have emerged as an important technology for future consumer electronics and electric vehicles. Intercalation of ions into channelled structures (‘bulk’) has been recognised as a promising mechanism for the enhancement of performance in supercapacitors and batteries. Two-dimensional (2D) materials are unique for ion intercalation because of the spacious interplanar paths for fast transport of ions. Unfortunately most of the natural and synthetic 2D layered materials are poor electronic conductors, and hence, are not ideal electrodes.

The popular 2D materials include graphene, transition metal carbides/sulfides/oxides, metal organic frameworks (MOFs) and covalent organic frameworks (COFs). Among these, only graphene, carbides, as well as some MOFs and COFs are good conductors. 2D organic-inorganic frameworks (such as MOFs) possess a wide range of sophisticated properties for emerging applications in sensing, supercapacitors, gas separation, and catalysis, which are attributable to the precise structural order, ultrathin thickness, and large surface area with highly accessible active sites. Nevertheless the density of these highly porous materials is low (<1 g cm⁻³), which is not sufficient for achieving high performance energy storage for small portable devices or on-board uses on electric vehicles. 2D layered materials that possess these properties of high electronic conductivity and high density are required to construct compact and powerful energy storage devices. It would therefore be advantageous to provide materials with these properties and methods for synthesising such materials.

It is to be understood that, if any prior art publication is referred to herein, such reference does not constitute an admission that the publication forms a part of the common general knowledge in the art, in Australia or any other country.

### SUMMARY

A first aspect of the invention provides an electrically conductive or semi-conductive lamellar structure comprising: a plurality of sheets, wherein each sheet comprises nanochains, wherein at least some of the nanochains are electrically conductive or semi-conductive, and crosslinking agents connecting adjacent nanochains.

In an embodiment, one of the nanochains and crosslinking agents acts as Lewis acids and the other of the crosslinking agents and nanochains act as Lewis bases, and each sheet is a Lewis adduct. In an embodiment, the nanochains act as Lewis bases and the crosslinking agents act as Lewis acids, and each sheet is a Lewis adduct.

In an embodiment, each sheet is formed from hydrogen bonds between the nanochains and the crosslinking agents.

In an embodiment, the crosslinking agents are multivalent.

In an embodiment, the sheets of the lamellar structure can be exfoliated.

In some embodiments, the lamellar structure is an electrically semi-conductive lamellar structure comprising: a plurality of sheets, wherein each sheet comprises electrically semi-conductive nanochains and crosslinking agents connecting adjacent semi-conductive nanochains.

In some embodiments, the lamellar structure is an electrically conductive lamellar structure comprising: a plurality of sheets, wherein each sheet comprises electrically conductive nanochains and crosslinking agents connecting adjacent conductive nanochains.

In an embodiment, the electrically conductive nanochains are electrically conductive polymer chains.

In an embodiment, the polymer chains include polyaniline. In an embodiment, the polyaniline is in the form of pernigraniline.

In an embodiment, the crosslinking agents comprise a metal or metal oxide. In an embodiment, the crosslinking agents are tungstic acid and/or molybdic acid.

In an embodiment, a basal spacing between adjacent sheets is greater than 5 Å. In an embodiment, the basal spacing is about 12 Å. In an embodiment, the basal spacing is about 11.8 Å. In some embodiments the basal spacing is adjustable depending on the type of solvent(s) and/or the ion(s) intercalated between adjacent sheets.

In an embodiment, the lamellar structure is able to electrochemically intercalate ions between adjacent sheets. In an embodiment, the ions include Li⁺, Na⁺, K⁺, Rb⁺, Cs⁺Mg²⁺, PF₆⁻, Cl⁻, and SO₄²⁻

In an embodiment, the lamellar structure has a capacitance of greater than 200 F cm⁻³.

In an embodiment, the capacitance is about 340-700 F cm⁻³.

In an embodiment, the lamellar structure has a porosity of less than about 100 m²g⁻¹.

In an embodiment, the porosity is less than about 50 m²g⁻¹. In an embodiment, the porosity is less than about 20 m²g⁻¹. In an embodiment, the porosity is about 16.5 m²g⁻¹.

In an embodiment, the lamellar structure has a conductance of about 6 S cm⁻¹.

In an embodiment, the lamellar structure has a density greater than about 1 g cm⁻³. In an embodiment, the lamellar structure has a density greater than about 2 g cm⁻³.

A second aspect of the invention provides a lamellar structure comprising: a plurality of sheets, wherein each sheet comprises polymer nanochains and crosslinking agents comprising a metal or metal oxide connecting adjacent nanochains.

In this aspect of the invention, the polymer nanochains may be electrically conductive or semi-conductive, or may be electrically non-conductive.

In an embodiment, the polymer nanochains include polyaniline. In an embodiment, the polyaniline is in the form of pernigraniline.

In an embodiment, the crosslinking agents are tungstic acid and/or molybdic acid.

In an embodiment, a basal spacing between adjacent sheets is greater than 5 Å. In an embodiment, the basal spacing is about 12 Å. In an embodiment, the basal spacing is about 11.8 Å.

In an embodiment, the lamellar structure is able to electrochemically intercalate electrolytes between adjacent sheets. In an embodiment, the electrolytes include one or more of the following: aqueous electrolytes of mono/di/tri/multi valent cations/anions including Li⁺, Na⁺, K⁺, Rb⁺, Cs⁺, Mg²⁺, Ca²⁺, Al³⁺, Zn²⁺, NO₃⁻, PF₆⁻, TFSl⁻, Cl⁻, F⁻, Br⁻, PO₃⁻ and/or SO₄²⁻, non-aqueous electrolytes with ester, ether groups and/or nitriles groups; organic solvents comprising mono/di/tri/multi valent cations/anions including Li⁺, Na⁺, K⁺, Rb⁺, Cs⁺, Mg²⁺, Ca²⁺, Al³⁺, Zn²⁺, OH⁻, NO₃⁻, PF₆⁻, TFSl⁻, Cl⁻, F⁻, Br⁻, PO₃⁻, and/or SO₄², and/or ionic liquids including-alkyl-3-methylimidazolium, 1-alkylpyridinium, N-methyl-N-alkylpyrrolidinium, ammonium and Phosphonium cations, and halide, tetrafluoroborate, hexafluorophosphate, bistriflimide, triflate or tosylate, formate, alkylsulfate, alkylphosphate and/or glycolate anions. In an embodiment, the ions include Li⁺, Na⁺, K⁺, Rb⁺, Cs⁺, Mg²⁺, PF₆⁻, Cl⁻, and SO₄²⁻.

In an embodiment, the lamellar structure has a porosity of less than about 100 m²g⁻¹.

In an embodiment, the porosity is less than about 50 m²g⁻¹. In an embodiment, the porosity is less than about 20 m²g⁻¹. In an embodiment, the porosity is about 16.5 m²g⁻¹.

In an embodiment, the lamellar structure has a density greater than about 1 g cm⁻³. In an embodiment, the lamellar structure has a density greater than about 2 g cm⁻³.

Another aspect of the invention provides a surface coated with a lamellar structure according to the first or second aspect.

In an embodiment, the surface is coated with a film of the lamellar structure.

In other embodiments, the surface is coated with a coating composition comprising particles of the lamellar structure and a binder. In such embodiments, the coating composition may optionally comprise further components in addition to the lamellar structure and the binder.

In an embodiment, the lamellar structure is electrically conductive and the surface is configured for use as a battery, supercapacitor, metal-ion capacitor, electrode, electrochemical sensor, electrocatalyst, fuel cell membrane and/or field-effect transistor, and/or for use in electrochemical desalination or gas separation processes.

A fourth aspect of the invention provides a method for preparing a lamellar structure, the method comprising: mixing a polymer precursor comprising a moiety capable of acting as a Lewis base with a multivalent Lewis acid crosslinker; and polymerising the polymer precursor to form a lamellar structure comprising polymer nanochains with adjacent polymer nanochains cross-linked by the multivalent Lewis acid crosslinker.

In an embodiment, the method further comprises the step of adjusting the pH of the mixture comprising the polymer precursor and multivalent Lewis acid crosslinker to be less than the pKa of the multivalent Lewis acid crosslinker.

In an embodiment, the pH is adjusted by adjusting the pH of a mixture comprising the polymer precursor prior to the mixture comprising the polymer precursor being mixed with the multivalent Lewis acid.

In an embodiment, polymerisation and crosslinking occurs simultaneously.

In an embodiment, the polymer precursor and the multivalent Lewis acid crosslinker are added together over a period of time.

In an embodiment, the method further comprises the step of isolating the lamellar structure by filtration. In an embodiment, the lamellar structure is washed and dried after filtration. In an embodiment, the lamellar structure is dried under vacuum. In an embodiment, the lamellar structure is dried under vacuum at a temperature above room temperature, for example, at about 80° C. In another embodiment, the lamellar structure is dried at about atmospheric pressure. In an embodiment, the lamellar structure is dried at about atmospheric pressure at a temperature above room temperature, e.g. from about room temperature to about 200° C.

In an embodiment, the multivalent Lewis acid crosslinker comprises a divalent metal oxide. In an embodiment, the divalent metal oxide is tungstic acid and/or molybdic acid, or hetero-multi-acid.

In an embodiment, the polymer precursor is capable of polymerising to form an electrically conductive polymer.

In an embodiment, the polymer precursor is aniline.

In an embodiment, a molar ratio of [aniline]:[divalent metal oxide salt] is 2:1.

In an embodiment, the method is performed on a surface to form a surface coated with the lamellar structure.

In an embodiment, the surface is not pre-treated prior to performing the method on the surface.

In an embodiment, the polymerisation is initiated with an oxidising agent.

In an embodiment, the oxidising agent is ammonium persulphate.

In an embodiment, the oxidising agent is mixed with the polymer precursor prior to mixing the polymer precursor with the crosslinker solution.

A fifth aspect of the invention provides a lamellar structure prepared using the method of the fourth aspect.

A sixth aspect of the invention provides a planar structure comprising nanochains, wherein at least some of the nanochains are electrically conductive or semi-conductive, and crosslinking agents connecting adjacent nanochains.

In an embodiment, the nanochains act as Lewis bases and the crosslinking agents act as Lewis acids, and the planar structure is a Lewis adduct.

In an embodiment, the crosslinking agents are multivalent.

In some embodiments, the planar structure is an electrically semi-conductive planar structure comprising electrically semi-conductive nanochains and crosslinking agents connecting adjacent electrically semi-conductive nanochains.

In some embodiments, the planar structure is an electrically conductive planar structure comprising electrically conductive nanochains and crosslinking agents connecting adjacent electrically conductive nanochains.

In an embodiment, the conductive nanochains are polymer chains.

In an embodiment, the polymer chains include polyaniline. In an embodiment, the polyaniline is in the form of pernigraniline.

In an embodiment, the crosslinking agents comprise a metal or metal oxide. In an embodiment, the crosslinking agents are tungstic acid and/or molybdic acid.

A seventh aspect of the invention provides a planar structure comprising polymer nanochains and crosslinking agents comprising a metal or metal oxide connecting adjacent nanochains.

In an embodiment, the polymer chains include polyaniline. In an embodiment, the polyaniline is in the form of pernigraniline.

In an embodiment, the crosslinking agents are tungstic acid and/or molybdic acid.

Another aspect of the invention provides an electrical device comprising the lamellar structure of the first, second or fifth aspect.

### BRIEF DESCRIPTION OF FIGURES

Preferred embodiments of the present invention are described below, by way of example only, with reference to the accompanying drawings in which:

FIG. 1a is a schematic illustration showing the in-plane growth mechanism of monolayer tungstic acid-linked pernigraniline (TALP).

FIG. 1b is a schematic illustration of the assembly mechanism of lamellar TALP.

FIG. 2a shows scanning electron microscopy (SEM) image of a cross-section of a TALP particle.

FIG. 2b shows a transmission electron microscopy (TEM) image of a TALP particle, showing the delamination of the layered lamellar structure particle.

FIG. 2c shows a XRD profile of TALP. The inset shows a bilayer structure model.

FIG. 2d shows an AFM image and height profile of exfoliated TALP sheets.

FIGS. 2e and 2f show a HR-TEM image of TALP sheets. For the structural model in f, the blue sphere is N, black is C, red is O, green is W.

FIG. 2g shows a SAED pattern of TALP sheets.

FIG. 2h shows an EDS elemental mapping for C, N, O and W in a TALP particle.

FIG. 2i shows Raman spectra for TALP and emeraldine doped with tungstic acid.

FIG. 2j shows a XPS N1s profile of TALP showing the mild shift in binding energy due to hydrogen bond between PB and TA.

FIG. 2k shows DSC and TGA profiles for TALP at low temperature, highlighting the cleavage of hydrogen bonds.

FIG. 3a shows an illustration of the liquid/solid interface-directed growth of TALP film. The substrate can either float at the surface of the precursor solution, or be covered by the solution.

FIG. 3b shows a photograph of films of TALP grown on several substrates (indium-tin oxide (ITO) glass, graphite felt, polypropylene, stainless steel, glass).

FIG. 3c shows a SEM image of the cross-section of TALP film grown on a glass substrate. The scale bar represents 1 μm.

FIG. 3d shows the dependence of the surface roughness of TALP film on the growth time. AFM images of the corresponding areas of interest were used to derive the roughness factor (Ra and Rms).

FIG. 4a shows CV profiles for a fresh TALP film and a NaOH-treated film.

FIG. 4b shows XRD patterns for the fresh TALP film and the NaOH-treated film of FIG. 4a.

FIG. 4c shows CV profiles for TALP film collected at 2 mV s⁻¹ in various mono-/divalent cation electrolytes (0.5 M) for supercapacitor application.

FIG. 4d shows cross-sectional SEM images of TALP films at different thicknesses on stainless steel substrates.

FIG. 4e shows CV profiles for TALP films with different thicknesses measured at 100 mV s⁻¹ in 0.5 M K₂SO₄ electrolyte.

FIG. 4f shows the relationship between the volumetric capacitance and the scan rate in various electrolyte solutions (0.5 M). Films with different thicknesses were compared.

FIG. 4g shows decoupled capacitive current relative to the total current for charge storage on TALP film.

FIG. 4h shows the power-law relationship between the current and the scan rate, as determined in various electrolytes (0.5 M).

FIG. 4i shows galvanostatic charge/discharge curves for TALP film (300 nm) in 0.5 M K₂SO₄ electrolyte.

FIG. 4j shows the cyclic stability for TALP film in 0.5 M K₂SO₄ electrolyte. The applied current was normalized to the film volume.

FIG. 5a shows the cyclic stability of TALP film electrode (900 nm) in 0.5 M K₂SO₄ electrolyte over 1000 cycles.

FIG. 5b shows XRD patterns for new and spent TALP electrodes.

FIG. 5c shows a structural illustration of the ion intercalation into the layered TALP structure, showing the slight increase in the basal spacing along the c-axis.

FIG. 6 shows the EDS analysis of the bulk composition of TALP showing the existence of C, N, O, and W elements.

FIG. 7a shows a TGA curve of TALP annealed in air at 10° C. min⁻¹ up to 1000° C.

FIG. 7b shows a photograph of an original TALP monolith and a TALP monolith sintered in air.

FIG. 7c shows the Raman spectrum for a TALP monolith sintered in air at 600° C. for 3 hours showing the WO₃ phase.

FIG. 8 shows XRD profiles of TALP synthesized with different crosslinker:monomer ratios.

FIG. 9 shows XRD profiles of TALP synthesized at different temperatures.

FIG. 10 shows photographs of the stable dispersion of an exfoliated TALP subject to ultrasonic agitation in various solvents.

FIG. 11 shows XRD of molybdic acid-linked pernigraniline.

FIG. 12 is a schematic illustration of the in-plane structure of TALP. The distance between the centre line of the linear chain of pernigraniline base and that of the tungstic acid is estimated to be 3.75 Å, in accordance with the HRTEM and SAED results shown in FIGS. 2e-g.

FIG. 13(a) shows Raman spectra of TALP and emeraldine doped with tungstic acid.

FIG. 13(b) illustrates the structure of polyaniline at its different states of oxidation and the corresponding protonated structure.

FIG. 14 shows XPS of TALP. O1s A represents the W═O bond. O1s B represents the W—OH bond.

FIG. 15 shows a schematic of a cell used for the measurement of the TALP film electrode.

FIG. 16 shows BET analysis result of the nitrogen adsorption on TALP.

FIG. 17 show CVs of TALP film in 0.5 M K₂SO₄ and KCl electrolytes.

FIG. 18 shows capacitive current contribution to the total charge storage. The shaded area is the capacitive current; the blank part is the diffusion-controlled current: (a) Na₂SO₄, (b), Rb₂SO₄, (c) Cs₂SO₄, (d) MgSO₄.

FIG. 19 shows the correlation of normalized capacitance with the reciprocal of the root square of scan rate (v^{-1/2}).

FIG. 20a) shows XRD patterns of TALP and polyaniline (PANI) powders.

FIG. 20b) shows a UV-vis spectrum for powders of TALP and PANI.

FIG. 20c) shows a SEM image of TALP powders with 2D layered structure.

FIG. 20d) shows a SEM image of PANI powders.

FIG. 21a) illustrates schematically solvent exchange in the process of electrode slurry preparation and electrolyte soaking.

FIG. 21b) shows XRD patterns of H₂O-TALP, NMP-TALP and electrolyte-TALP.

FIG. 22a) shows CV profiles of TALP and PANI at a scan rate of 1 mV/s in a voltage range of 1.5-4.5V (V vs. Li⁺/Li).

FIG. 22b) shows comparison of charge storage for TALP at scan rates ranging from 0.1 to 1 mV/s in a voltage range of 1.5-4.5V (V vs. Li⁺/Li).

FIG. 22c) shows XRD patterns of TALP electrodes at different potentials.

FIG. 22d) shows P/N and Li/N ratios at potentials of 1.5V, 4.5V and OCV (˜3.2V, V vs. Li⁺/Li) resulting from XPS.

FIG. 23a) shows a surface SEM image of TALP thin-film electrode.

FIG. 23b) shows a cross-section SEM image of TALP thin-film electrode.

FIG. 23c) shows an XRD pattern of TALP thin-film electrode,

FIG. 23d)-f) shows differentiation of the capacity contribution from capacitive and non-capacitive process with the CV scan rate of (d) 0.2 mV s⁻¹, (e) 0.3 mV s⁻¹ and (f) 0.8 mV s⁻¹.

FIG. 24a) shows an XPS survey of TALP powder and TALP electrodes at potentials of 4.5V and 1.5V (V vs. Li⁺/Li).

FIG. 24b) shows an XPS C1s spectra of TALP powder and TALP electrodes at potentials of 4.5V and 1.5V (V vs. Li⁺/Li).

FIG. 24c) shows an XPS N1s spectra of TALP powder and TALP electrodes at potentials of 4.5V and 1.5V (V vs. Li⁺/Li).

FIG. 24d) shows an XPS W4f spectra of TALP powder and TALP electrodes at potentials of 4.5V and 1.5V (V vs. Li⁺/Li).

FIG. 25a) shows rate performances of TALP electrode and PANI electrode at current densities ranging from 50 to 2000 mA/g.

FIG. 25b) shows galvanostatic charge/discharge (GCD) profiles of TALP electrode and PANI electrode at current densities of 50 and 500 mA/g.

FIG. 25c) shows GCD profiles of TALP electrode at current densities of 50, 100, 200, 500, 1000 and 2000 mA/g.

FIG. 25d) shows cycle performances with discharge volumetric capacity of TALP electrode and PANI electrode at a current density of 200 mA/g.

FIG. 26a) shows columbic efficiency of TALP and PANI under different current density.

FIG. 26b) shows GCD curve of TALP under different current density.

FIG. 26c) shows GCD curve of PANI under different current density.

FIG. 27a) shows Nyquist plots of a TALP electrode and a PANI electrode at OCV.

FIG. 27b) shows Bode plots of a TALP electrode and a PANI electrode.

FIG. 28 shows an SEM image of a cross-section of a TALP cathode.

FIG. 29a shows digital photos of an original TALP powder and a TALP electrode.

FIG. 29b shows digital photos of TALP electrodes after 1^{st}, 2^{nd} and 10^{th} compression and associated SEM images of the top surface.

FIG. 30a illustrates schematically TALP pellet structural variations at different length scales.

FIG. 30b shows a cross sectional image of a TALP pellet prepared from a pressing process that caused TALP particle deformation and gap filling.

FIG. 30c shows a cross section image of TALP particle in pellet. The black dots indicate mesoscopic tunnels based on nanoflake wrinkle.

FIG. 30d shows an XRD pattern comparison of original TALP powder and a TALP pellet after different pressing number of times indicates interlayer space expansion.

FIG. 30e shows gravimetric specific capacitance and capacitance per surface area of TALP pellet.

FIG. 31 shows particle size distribution of original TALP powder and grinded TALP electrode.

FIG. 32 shows images of an original TALP particle and a cross-sectional image of compressed TALP electrode showing the gaps among particles that are filled after mechanical compression.

FIG. 33a shows SPECS current response of tablet pressed (Tp)-TALP pellet (in 1 M Na₂SO₄ aqueous solution; potential step is 25 mV; equilibration time is 300 s).

FIG. 33b shows s current fitting curve of s TALP pellet at potential of 350 mV (vs. SCE).

FIG. 33c shows capacitance contribution to a TALP pellet from different electrochemical processes in one charge-discharge cycle.

FIG. 33d shows cyclic voltammograms (CV) curves of Tp-TALP pellets (in 1 M Na₂SO₄ aqueous solution; scan rate is 1 mV/s).

FIG. 33e shows specific capacitances of Tp-TALP pellets, using galvanostatic charge discharge (GCD) method.

FIG. 33f shows Nyquist plots of Tp-TALP pellets with an open circuit potential (OCP).

FIG. 34a shows CV curve comparisons of 1^{st} Tp-TALP and 2^{nd} Tp-TALP electrodes with different mass loading (scan rate=2 mV s⁻¹).

FIGS. 34b and c show capacitance comparisons of 1^{st} Tp-TALP and 2^{nd} Tp-TALP electrodes with different mass loading under different current density.

FIG. 34d show a Ragone plot of 1^{st} Tp-TALP and 2^{nd} Tp-TALP electrodes.

FIG. 35a shows a GCD profile of Tp-TALP∥HPGM supercapacitor (current density=50 mA g⁻¹).

FIG. 35b shows a GCD profile of Tp-TALPIIHPGM supercapacitor under different current density.

FIG. 35c shows a CV curve of Tp-TALPIIHPGM supercapacitor.

FIG. 35d shows a Ragone plot of Tp-TALP∥HPGM supercapacitor.

### DETAILED DESCRIPTION OF EMBODIMENTS

A first aspect of the invention provides an electrically conductive or semi-conductive lamellar structure comprising: a plurality of sheets, wherein each sheet comprises nanochains, wherein at least some of the nanochains are electrically conductive or semi-conductive, and crosslinking agents connecting adjacent nanochains.

The nanochains may be covalently bonded to the crosslinking agents to form each sheet of the plurality of sheets. Alternatively, the nanochains may be associated with the crosslinking agents through intermolecular attractions. Such intermolecular attractions include Van der Waal forces, use of Lewis acids and Lewis bases to form a Lewis adduct and/or hydrogen bonding. When Lewis adducts are formed, the nanochains may act as a Lewis base and the crosslinking agents may act as a Lewis acid. Alternatively, the nanochains may act as a Lewis acid and the crosslinking agents may act as a Lewis base. Whatever interaction(s) are used between the nanochains and crosslinking agents, the resulting interaction(s) form each sheet of the plurality of sheets. For example, when Lewis acids and Lewis bases are used as the nanochains and crosslinking agents, each resulting sheet is a Lewis adduct. The Lewis base may be in the form of proton acceptors, and the Lewis acid may be in the form of proton donors. For example, the Lewis base may comprise a diketone, sulfonyl, amine and/or imine group, and the Lewis acid may comprise a hydroxyl group, carboxyl group, a boric acid derivative and/or metal ion. In this way, each sheet can be formed through hydrogen bonds between the Lewis base and the Lewis acid, for example, hydrogen bonds between imines and carboxyl groups. In one embodiment, the nanochains have imine groups and the crosslinking agents have carboxyl groups.

In an embodiment, the crosslinking agents are multivalent. The crosslinking agents may be divalent and/or trivalent. A combination of divalent and trivalent crosslinking agents may be used. In an embodiment, the crosslinking agents are divalent. Valencies higher than trivalent may also be used. The resulting structure of each sheet of the plurality of sheets is dependent on the orientation of the crosslinking agent. For example, when the crosslinking agent is a tetrahedral divalent compound, the resulting sheet adopts a 2D configuration such that it resembles a generally planar sheet such as a graphene analogue. This is because each crosslinker is only capable of connecting two adjacent nanochains along a common plane. If the crosslinking agents are trivalent, then each crosslinker can connect two adjacent nanochains, plus an additional nanochain, so the three connected nanochains may not be on a common plane. This can result in higher ordered structures, such as 3D structures including hyperbranched structures. The resulting architecture of each sheet can be determined by the type of crosslinking agent. In some embodiments, the plurality of sheets is made up from a combination of different sheet architectures. In other embodiments, each sheet of the plurality of sheets has the same architecture. In one embodiment, each sheet of the plurality of sheets has an architecture that is generally planar.

The crosslinking agents may be a metal, metal oxide and/or organic compound. The crosslinking agents may comprise salts of a metal, metal oxide and/or organic compound. A combination of crosslinking agents may be used. In an embodiment, the crosslinking agents comprise a metal or metal oxide. When a metal oxide is used, it may be in the form of an acid. In an embodiment, the crosslinking agent is tungstic acid and/or molybdic acid. In an embodiment, the crosslinking agent is titanic acid. In another embodiment, the crosslinking agent is a heteropoly acid. In an embodiment, the crosslinking agent is a mineral acid such as boric acid. When organic compounds are used as the crosslinking agent, they may, for example, be a dicarboxylate. In an embodiment, the dicarboxylate is a ethanedioic, propanedioic, butanedioic, pentanedioic, hexanedioic, heptanedioic, octanedioic, nonanedioic, decanedioic, undecanedioic, dodecanedioic, tridecanedioic and/or hexadecanedioic acid, and/or its unsaturated form such as maleic acid or fumaric acid. When the crosslinking agent is an organic compound, it may have two or more moieties that act as a Lewis acid. For example, the crosslinking agent may be a diammonium compound. The diammonium compound may be based on 1,4-diazabicyclo[2.2.2]octane (DABCO). Other organic-based crosslinking agents may include silicic acid and/or carbonic acid.

The term “nanochain” as used herein refers to a linear structure having at least two dimensions in the range of 0.1 nm to 1000 nm, typically in the range of 0.1 nm to 100 nm. For example, in some embodiments, the nanochains are individual polymer chains. Typically the polymer chains have a thickness from about 0.1 nm to about 10 nm, width from about 0.5 nm to about 10 nm and a length of greater than about 20 nm, for example, a thickness from about 0.1 nm to 10 nm, width from about 1 nm to 10 nm, and length of greater than about 50 nm. In such embodiments, the crosslinking agents crosslink adjacent linear polymer chains to form a network, where the network forms a sheet of the plurality of sheets. More than one type of polymer chain can be used. For example, two, three, four or more types of different polymer chains can be used as the nanochains. Different isomeric forms of polymer chains can be used. For example, the polymer chains may be present in the cis and/or trans forms. The polymer chains may have different oxidation states. The polymer chains may have all the same oxidation state, or a combination of different oxidation states. For example, each individual polymer chain may have different oxidation states within the chain itself, such as the different forms of polyaniline, or individual polymer chains may wholly have be of the same oxidation state but different polymer chains have different oxidation states. In embodiments when the polymer chains include polyaniline, the polyaniline may be the form of leucoemeraldine, emeraldine and/or pernigraniline. The polyaniline may be oxidised to emeraldine and/or pernigraniline during polymerisation. In an embodiment, polyaniline is in the form of pernigraniline. In an embodiment, the polymer chains include conducting polymers, such as polypyrrole and/or poly(3,4-ethylenedioxythiophene). A mixture of polymer chains may be used, such as polyaniline and polypyrrole.

In some embodiments, the nanochains are electrically conductive, that is, they are able to conduct electronic charge. In some embodiments, the nanochains are electrically semi-conductive, that is they have a conductance from about 1 S cm⁻¹ to about 1000 S cm⁻¹.

In the first aspect of the present invention, each sheet of the lamellar structure comprises electrically conductive or semi-conductive nanochains. Typically all, or substantially all, of the nanochains in each sheet are electrically conductive nanochains or electrically semi-conductive nanochains. However, in some embodiments, each sheet may comprise a proportion of electrically conductive nanochains and a proportion of electrically semi-conductive nanochains. In some embodiments, each sheet may optionally further comprise some electrically non-conductive nanochains.

In the fourth and fifth aspects of the present invention, each sheet of the lamellar structure may comprise nanochains having any type of electrical conductivity and the nanochains may, for example, be electrically conductive, electrically semi-conductive or electrically non-conductive.

As those skilled in the art will appreciate, a conductive or semi-conductive polymer may itself be conductive (e.g. a linear polymer having a conjugated system) or semi-conductive and/or may require a dopant (e.g. an ionically charged species) in order for the polymer to form conductive, e.g. highly conductive, or semi-conductive pathways and to be capable of passing electronic charges. In the lamellar or planar structures of the present invention, the dopant may be provided by the cross-linking agent. For example, conductive polymers may have a conductance of greater than 1000 S cm⁻¹. For example, semi-conductive polymers may have a conductance of from about 1 S cm⁻¹ to about 1000 S cm⁻¹.

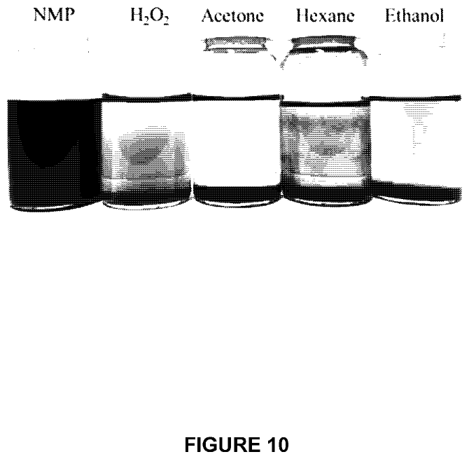

Each sheet of the plurality of sheets may be covalently bonded to one another and/or be connected to one another through intermolecular interactions. Electrostatic forces may include hydrogen bonding and/or Van der Waal interactions such as pi stacking. In embodiments when each sheet is connected to one another through intermolecular interactions, each sheet may be able to move relative to one another e.g. a basal spacing between adjacent sheets may be adjustable. This may allow individual sheets to be removed, such as exfoliation of the lamellar structure, to provide a planar structure comprising nanochains with crosslinking agents connecting adjacent nanochains. FIG. 10 shows a lamellar structure subjected to ultrasonic agitation to exfoliate the structure in a variety of solvents to form dispersions. In some embodiments, the lamellar structure is exfoliated until there are only two sheets remaining. In some embodiments, the lamellar structure is exfoliated until there is only one sheet remaining. This process may be used to exfoliate a lamellar structure of the first aspect to provide a planar structure comprising electrically conductive or semi-conductive nanochains and crosslinking agents connecting adjacent nanochains.

The nanochains may include moieties that assist in exfoliation, such as moieties that aid in solubilisation of individual sheets. The type(s) of moieties that aid in solubilisation will depend on the solvent(s) used for exfoliation. For example, polar moieties such as hydroxyl groups may be used to assist in solubilising the sheets in polar solvent such as N-methyl-2-pyrrolidone (NMP), and non-polar groups such as short alkyl chains may be used to assist in solubilising the sheets in polar solvents such as hexanes. The term “alkyl” as used herein is to be interpreted broadly to include alkyl chains as well as the alkyl portions of other groups such as arylC1-6alkyl, heteroarylC1-6alkyl etc.

The lamellar structure comprises a plurality of adjacent sheets that are stacked one on top of another. Put another way, two or more sheets are stacked on top of one another to form the lamellar structure. Each sheet is spaced apart from adjacent sheet(s). The type of nanochains and/or crosslinking agents can determine the distance between adjacent sheets. For example, moieties on the crosslinking agents can keep adjacent sheets from moving towards one another. For example, in embodiments where the crosslinking agent is tungstic acid, the W═O bonds from adjacent tungstic acid crosslinking agents extend approximately perpendicular to the plane of each sheet towards each other. The electrostatic repulsion between the adjacent W═O bonds means that the tungstic acid crosslinking agents help to separate adjacent sheets. The O of the W═O bonds may lie in a plane that is parallel and spaced apart by about 4.9 Å relative to the plane of a sheet. In an embodiment, the basal spacing between adjacent sheets is greater than 5 Å. The basal spacing is the distance between adjacent sheets, such as a distance between the planes of adjacent sheets.

In an embodiment, the basal spacing is such that the lamellar structure is able to electrochemically intercalate organic and/or inorganic electrolytes (e.g. cations or anions) between adjacent sheets. Intercalation of electrolytes means that electrolytes are able to fit between adjacent sheets so as to be reversibly sandwiched therebetween. The term “electrolyte” is to be interpreted broadly to include organic, inorganic, aqueous and non-aqueous electrolytes capable of balancing and/or carrying a charge. In an embodiment, the lamellar structure is able to intercalate, in their fully, partially and/or non-hydrated forms, one or more of the following: aqueous electrolytes of mono/di/tri/multi valent cations/anions including Li⁺, Na⁺, K⁺, Rb⁺, Cs⁺, Mg²⁺, Ca²⁺, Al³⁺, Zn²⁺, OR, NO₃⁻, PF₆⁻, TFSl⁻, Cl⁻, F⁻, Br⁻, PO₃⁻ and/or SO₄²⁻, non-aqueous electrolytes with ester, ether groups and/or nitriles groups, organic solvents comprising mono/di/tri/multi valent cations/anions including Li⁺, Na⁺, K⁺, Rb⁺, Cs⁺, Mg²⁺, Ca²⁺, Al³⁺, Zn²⁺, OH⁻, NO₃⁻, PF₆⁻, TFSl⁻, Cl⁻, F⁻, Br⁻, PO₃⁻ and/or SO₄², and/or ionic liquids including-alkyl-3-methylimidazolium, 1-alkylpyridinium, N-methyl-N-alkylpyrrolidinium, ammonium and phosphonium cations, and halide, tetrafluoroborate, hexafluorophosphate, bistriflimide, triflate or tosylate, formate, alkylsulfate, alkylphosphate and/or glycolate anions. In an embodiment, the basal spacing between adjacent sheets is greater than 10 Å. In an embodiment, the basal spacing is about 3.5 times of the hydrated K⁺ ion (3.3 Å). In an embodiment, the basal spacing is in a range of about 5-20 Å. The basal spacing may be about 12 Å. In an embodiment, the basal spacing is about 11.8 Å. The ion(s) intercalated between adjacent sheets can alter the electrochemical properties of the lamellar structure.

With a basal spacing of around e.g. 11.8 Å, organic electrolyte solvents, including N-Methyl-2-pyrrolidone (NMP), ethylene carbonate and/or ethyl methyl carbonate (for example EC/EMC, 1:1 in volume ratio), are able to diffuse into the interlayer and replace the structural water that may be retained between adjacent sheets, forming the nanoconfined fluid. An organic electrolyte may be used when the lamellar structure is used as a lithium capacitor. The basal spacing may be adjustable depending on the solvent type(s) e.g. organic vs aqueous forming the nanoconfined fluid between adjacent sheets. In some embodiments the lamellar structure is expanded by mechanical swelling. For example, repeated mechanical tableting pressing may create mesoscopic-level structural tunnels and interlayer space expansion. Expansion may help to increase the energy and power density (e.g. capacitance) of an embodiment of the lamellar structure.

The crosslinking agents can have an ordered arrangement within the lamellar structure. For example, each nanochain may have a series of bonding moieties extending along the length of the nanochain that act as Lewis bases. The term “bonding moiety” as used herein refers to moieties that can act as crosslinking sites. For example, when crosslinking is formed by the formation of a Lewis adduct, the bonding moiety can be the respective Lewis acid or Lewis base.

The crosslinking agents may be positioned on alternate sides of the nanochain between sequential bonding moieties, resulting in a sheet that has crosslinking agents being positioned on either side of the plane of the sheet in a “left-right-left-right . . . ” or “up-down-up-down . . . ” orientation. Use of the terms left and right and up and down is to be interpreted broadly as relative terms to indicate opposite sides of the plane of the sheet and does not limit the orientation of the sheets and lamellar structure to any particular orientation.

In some embodiments, the lamellar structure is electrically conductive and can intercalate ions. As such, the lamellar structures can be used as a capacitor. The capacitor may be a thin film capacitor. The thin film capacitor may have a thickness less than 1 μm. The thin film capacitor may be an electrode, for example having a thickness of greater than 1 μm, or greater than 100 μm. The capacitance of the lamellar structure can be dependent on the basal spacing between sheets, how easily the ions can intercalate, the type of ion (e.g. inorganic vs organic, polar vs non-polar), and the density of the lamellar structure. For example, in one embodiment, the lamellar structure has a capacitance of greater than 200 F cm⁻³. In some embodiments, the lamellar structure has a capacitance of about 200 to about 2000 F cm⁻³, e.g. about 200 to about 1500 F cm⁻³, about 250 to about 1000 F cm⁻³, or about 300 to about 800 F cm⁻³. In some embodiments, the capacitance is about 300, 350, 400, 450, 500, 550, 600, 650, 700, 750, 800, 850, 900, 950 or 1000 F cm⁻³. In an embodiment, the capacitance is about 340-700 F cm⁻³. Some embodiments have a capacitance greater than 700 F cm⁻³. For example, the capacitance may be about 700-2000 F cm⁻³ such as about 1500-2000 F cm⁻³. In some embodiments, the capacitance is dependant on a volume of the lamellar structure (e.g. the basal spacing).

Typically, decreases in the porosity of conducting lamellar structures increases the capacitance. Therefore, producing a conductive lamellar structure with a low porosity may help to provide a lamellar structure with sufficient capacitance to allow it to be used, for example, as a supercapacitor. In an embodiment, the lamellar structure has a porosity of less than about 100, 75, 50, 25, 20, 15, 20 or 5 m²g⁻¹. In an embodiment, the porosity is about 0.5 to about 100 m²g⁻¹, e.g. about 1 to about 50 m²g⁻¹. In an embodiment, the porosity is about 16.5 m²g⁻¹. Linked to the porosity is the density of the lamellar structure. It can usually be the case that a decrease in porosity results in an increase in density. Since dense lamellar structures tend to be more suitable for use as capacitors, a dense lamellar structure may be beneficial. In some embodiments, the lamellar structure may have a density of about 1 to about 5 gcm⁻³, e.g. 1, 2, 3, 4 or 5 gcm⁻³, where the density is the density of the lamellar structure itself or the density of a material e.g. trapped powder comprising the lamellar structure. In an embodiment, the lamellar structure has a density greater than about 1 gcm⁻³. In an embodiment, the lamellar structure has a density greater than about 2 gcm⁻³. The conductance of the electrically conductive or semi-conductive lamellar structure may be dependent on the type of nanochains, the type of the crosslinking agent, the architecture of the sheets, and the spacing between adjacent sheets. In an embodiment, the conductance is dependent on a dopant (e.g. type and concentration) and the type of nanochain. In an embodiment, the lamellar structure has a conductance of about 0.1 to 500 S cm⁻¹. In an embodiment the lamellar structure has a conductance of about 6 S cm⁻¹. The conductivity of the lamellar structure may be comparable with that of carbon materials (ca. 1 to 10 S cm⁻¹).

A second aspect of the invention provides a lamellar structure comprising: a plurality of sheets, wherein each sheet comprises polymer nanochains and crosslinking agents comprising a metal or metal oxide connecting adjacent nanochains.

In this aspect of the invention, the polymer nanochains may be electrically conductive or semi-conductive, or may be electrically non-conductive. The polymer nanochains may be as described above for the first aspect. In some embodiments, the polymer nanochains are polyaniline.

The crosslinking agents comprising a metal or metal oxide may be a crosslinking agent comprising a metal or metal oxide as described above for the first aspect. In an embodiment, the crosslinking agents are tungstic acid and/or molybdic acid.

Another aspect of the invention provides a surface coated with a lamellar structure according to the first or second aspect.

In some embodiments, the surface is coated with a film consisting of the lamellar structure. The thickness of the film of the lamellar structure may, for example, vary from about 1 nm (i.e. the thickness of a lamellar structure with about two sheets) up to several mm. In some embodiments, the thickness of the film is less than about 100 microns. In some embodiments, the thickness of the film is about 1 nm to about 10 μm, e.g. about 10 nm to about 10 μm, about 10 nm to about 3 μm or about 10 nm to about 1 μm, thick. In some embodiments, the thickness of the film is about 80 nm, about 300 nm or about 900 nm. Typically, the capacitance of the film increases as the film thickness increases.

For embodiments where the surface is the surface of a glass, plastic or other transparent and/or translucent substrate, the substrate coated with the film of the lamellar structure may be used for applications including, for example, windows or energy storage.

In some embodiments, the surface is coated with a composition comprising particles of the lamellar structure and a binder, and optionally one or more other components. The thickness of the coating can vary from about 1 nm up to several mm. In some embodiments, the thickness of the coating is less than about 100 microns. In some embodiments, the thickness of the coating is about 1 nm to about 10 μm, e.g. about 10 nm to about 10 μm, about 10 nm to about 3 μm or about 10 nm to about 1 μm, thick. In some embodiments, the thickness of the coating is about 80 nm, about 300 nm or about 900 nm.

The surface may be the surface of a conductive substrate or the surface of a generally non-conductive substrate. The conductive substrate may act as an electrode. The conductive substrate may be carbon such as graphene/graphite-based including graphite felt. Alternatively, the conductive substrate may be metal-based. Metal-based substrates include stainless steel, platinum, gold, indium and rhodium, and their alloys such as indium-tin oxide and glass indium-tin oxide. The substrate may be glass. Alternatively, the substrate may be a plastic, such as polypropylene, polyethylene terephthalate and polytetrafluoroethylene (Teflon).

In an embodiment, the lamellar structure is prepared directly on the surface. In other embodiments, the lamellar structure is first prepared then bonded to the surface. The lamellar structure may be present on the surface as a film, such as a thin film. Adhesives may be used to bond the lamellar structure to the surface. However, to maximize the volumetric performance of the lamellar structure, it can be desirable to develop binder-free (i.e. adhesive free) electrodes. Minimising or eliminating the amount of binder can help to increase the density of the electrode. For embodiments where the lamellar structure is electrically conductive, the binder, if used, should ideally be conductive, or used with other conductive additives such as carbons or metals.

The surface may be pre-treated prior to applying the lamellar structure to the surface. The surface may be pre-treated using physical processes (e.g. grinding) or chemical processes (e.g. plasma etching, chemical etching, vapour deposition etc.). In some embodiments, the surface is not pre-treated prior to applying the lamellar structure. The surface may be the surface of a flexible substrate or a rigid substrate. The lamellar structure may be sandwiched between substrates.

In some embodiments the lamellar structure is formed as solid structure, for example a pellet or tablet. The solid structure may include binders. The solid structure may include bulking agents, such as graphite/graphene or other conductive materials. The solid structure may be bonded to a surface. In an embodiment, a tablet pressing process is used to form a tablet comprising the lamellar structure. For example, in an embodiment, a powder of the lamellar structure is optionally mixed with a conductive additive, such as graphene, and optionally a binder and pressed in a press to bind the lamellar structure, optional conductive additive and optional binder into a solid structure. The solid structure may be used as a capacitor, super capacitor, electrode, sensor and the like. An embodiment of the invention provides an electrical device comprising an embodiment of the lamellar structure. The electrical device may be a capacitor, super capacitor, electrode, battery, metal-ion capacitor, field-effect transistor electrode, or solar cells.

In an embodiment, the surface is configured for use in electrical applications. Such applications include use as a battery, capacitors, supercapacitor, metal-ion capacitor, field-effect transistor electrode, or solar cells. The supercapacitor may be a high energy supercapacitor. The capacitor and/or supercapacitor may be a lithium ion capacitor. An embodiment may provide a TALP structure that can act as a high energy supercapacitor from mechanically swelled layered electrodes. The ions intercalated between adjacent sheets can alter the electrochemical properties of the lamellar structure. Therefore, in some embodiments, the surface is used as an electrochemical sensor. Sensors may be templated with target molecule(s). The sensors may operate by monitoring changes in the electrochemical properties of the lamellar structure. For example, the presence of heavy metals such as mercury may alter the electrochemistry of the lamellar structure.

The electrical properties of the lamellar structure and the ability to intercalate different ion(s) means that the lamellar structure can be used as an electrocatalyst in some embodiments. Electrocatalysts may be used, for example, to electrochemically split water into hydrogen and oxygen, or in Fischer-Tropsch processes in the production of hydrocarbons. Changes in electrochemical properties of the lamellar structure can alter the ability of molecules to associate with the lamellar structure. For example, changes in the electrical and/or electrochemical properties may change the ability of protons to pass through the lamellar structure. Lamellar structures that allow selective transport of protons can be used in fuel cell applications. Alternatively, some embodiments may allow the structure to be used in electrometrical desalination by selectively allowing specific ion(s) to pass through the lamellar structure. The lamellar structure may also allow selective passage of molecules such as gases. In these embodiments, the surface can be used in gas separation processes, for example separation of H₂ from CO and N₂.

A fourth aspect of the invention provides a method for preparing a lamellar structure. The method comprises: mixing a polymer precursor comprising a moiety capable of acting as a Lewis base with a multivalent Lewis acid crosslinker; and polymerising the polymer precursor to form a lamellar structure comprising polymer nanochains with adjacent polymer nanochains cross-linked by the multivalent Lewis acid crosslinker. The method may be used to prepare lamellar structures of the first or second aspect of the invention.

The term “polymer precursor” as used herein refers to monomers and/or oligomers that are capable of being polymerised to form individual polymer chains (nanochains). The monomer and/or oligomer may be a single molecule(s) and/or a macromolecule(s).

In some embodiments, two or more polymer precursors may be polymerised together, wherein at least one of the polymer precursors comprises a moiety capable of acting as a Lewis base. For example, two or more monomers having different reactivities can be used to give rise to various polymer architectures, such as ABA or block copolymers such as [block A]-[block B]. When two or more monomers and/or oligomers are used, one of the monomers and/or oligomers may give rise to specific properties, such increased solubility to assist in exfoliation. In an embodiment, the polymer precursor comprising a moiety capable of acting as a Lewis base is aniline. The polymer precursor may include derivatives of aniline. Other monomers comprising a moiety capable of acting as a Lewis base include pyrrole or thiophene. Other monomers may include acrylates, methacrylates, vinyls, alkenes and/or alkynes and/or their derivatives. In some embodiments, the polymer formed from the polymer precursor(s) is a conductive polymer. The choice of monomer(s) and/or macromolecule(s) as the polymer precursor may result in specific polymer architectures such as polymer combs. In some embodiments, functional groups on a polymer precursor are modified to provide the polymer precursor comprising a moiety capable of acting as a Lewis base prior to the polymer precursor comprising a moiety capable of acting as a Lewis base being used in the method of the fourth aspect.

In the method, the crosslinking agent acts as a Lewis acid. Therefore, the compound acting as the Lewis acid crosslinking agent needs to have two or more moieties that act as Lewis acids. The multivalent crosslinking agent may be an organic compound, such as a dicarboxylic acid. In an embodiment, the multivalent Lewis acid crosslinker comprises a divalent metal oxide. In an embodiment, the divalent metal oxide is tungstic acid and/or molybdic acid. Alternatively, in an embodiment, divalent metal oxide is a heteropoly acid. The tungstic acid, molybdic acid and/or heteropoly acid may be provided as a salt that is converted to the respective acid during mixing and/or polymerisation. For example, tungstic acid may be provided as ammonium metatungstate and molybdic acid may be provided as ammonium molybdate.

The molar ratio of polymer precursor comprising a moiety capable of acting as a Lewis base and crosslinking agent depends on the type of polymer precursor and crosslinking agent, the number of bonding moieties on the nanochains, and the desired lamellar architecture. The valency of the crosslinking agent also affects the [polymer precursor]:[crosslinking agent] ratio since a divalent crosslinker will behave differently to a trivalent or higher valent crosslinker. The ratio of [polymer precursor]:[crosslinking agent] can also be used to determine what type of lamellar structure is formed. A molar ratio of [polymer precursor]:[crosslinking agent] may be in the range of about 1:1 to about 100:1, e.g. about 1:1 to about 50:1, or about 2:1, about 5:1, about 10:1, about 20:1 or about 50:1. In an embodiment, for a multivalent crosslinking agent having a valency of n, the molar ratio of [polymer precursor]:[crosslinking agent] may, for example, be between 1:1 to n:1. In an embodiment, a molar ratio of [polymer precursor]:[divalent metal oxide salt] is 2:1. In this embodiment, the polymer precursor can be aniline.

The polymer precursor and the multivalent Lewis acid crosslinker may be provided as separate mixtures. The mixtures may be solutions. The solutions may be aqueous. The pH of the aqueous solutions may be adjusted during mixing and/or polymerisation. In an embodiment, the pH of the mixture comprising the polymer precursor and multivalent Lewis acid crosslinker is less than the pKa of the multivalent Lewis acid crosslinker. In these embodiments, the multivalent Lewis acid crosslinker remains protonated during polymerisation. The pH may be adjusted before or after the polymer precursor and the multivalent Lewis acid crosslinker are mixed. In an embodiment, the pH of a mixture comprising the polymer precursor is adjusted to be less than the pKa of the multivalent crosslinker prior to the mixture comprising the polymer precursor being mixed with the multivalent Lewis acid crosslinker. The acid used to adjust the pH may have an anion that is the same as the anion of the ions that can intercalate between adjacent sheets. The acids may be inert to electrochemical processes. The acid may be a mineral acid, such as HCl or H₂SO₄. Organic acids may be used to adjust the pH.

The polymer precursor may be added to the multivalent Lewis acid. Alternatively, the multivalent Lewis acid crosslinker may be added to the polymer precursor. The polymer precursor and the multivalent Lewis acid crosslinker may be added together at an even rate. Alternatively, the polymer precursor and the multivalent Lewis acid crosslinker may be added together at an uneven rate to form either polymer precursor starved conditions or crosslinker starved conditions.

Polymer precursor starved conditions or crosslinker starved conditions can be used to form specific polymer architectures. Polymer precursor starved conditions or crosslinker starved conditions may also be required depending on the polymer precursor type. For example, to form sheets having a specific architecture, it may be useful to polymerise the polymer precursors to form specific oligomers then to further polymerise the oligomers to form specific polymers e.g. nanochains. The term “polymer precursor starved conditions” as use herein also applies to embodiments when two or more polymer precursors are used, such as polymer precursors A and B. In these embodiments, polymer precursors A and B may be starved relative to the multivalent crosslinking agent. Alternatively, polymer precursor A may be starved relative to polymer precursor B, or vice versa. In an embodiment, the polymer precursor is added to the multivalent Lewis acid crosslinker over a defined period of time. When the polymer precursor and multivalent Lewis acid crosslinker are provided as solutions, they may be added together dropwise.

Mixing the polymer precursor and the multivalent Lewis acid crosslinker and polymerising and crosslinking the polymer precursor and the multivalent Lewis acid crosslinker may be carried out at sequentially as different steps, or they may be performed concurrently. The type of polymer precursors and multivalent Lewis acid crosslinking agent, and the desired architecture of the resulting lamellar structure may determine whether polymerisation and crosslinking occur sequentially or concurrently. In an embodiment, polymerisation and crosslinking occurs simultaneously. In this way, the method can be considered an in situ process where the polymer precursor and the crosslinking agent are converted into the crosslinked nanochains. For example, when monomers are used as the polymer precursor, the monomers may react with one another to form a dimer, then the dimer may react with the crosslinking agents to form oligomers, and the oligomers may then react with other oligomers and/or monomers to form the polymer. In an embodiment, the monomers and crosslinker are used to form oligomer “seeds” which then react further to form sheets. The sheets can then align themselves with one another to form the lamellar structure.

The type of initiation required for polymerisation will be determined by the type(s) of polymer precursor. Polymerisation may be initiated using thermal, redox and/or UV processes. A combination of initiation processes may be used. For example, thermal initiation may be used to polymerise the polymer precursors, and UV irradiation may be used as a curing step. In an embodiment, polymerisation is initiated with an oxidising agent. The oxidising agent may be ammonium persulphate. Other oxidising agents may be used, such as FeCl₃. Alternatively, the oxidising agent may be provided by electrochemical oxidation. More than one form of oxidising agent may be used. When the polymer precursor is aniline, the oxidising agent may also help to oxidise the resulting polyaniline into emeraldine and/or pernigraniline. In an embodiment, polyaniline is oxidised into pernigraniline by an initiator that is an oxidising agent. The initiator can be is mixed with the polymer precursor prior, during or after mixing the polymer precursor with the crosslinker solution. In an embodiment, the oxidising agent is mixed with the crosslinker prior to mixing the polymer precursor with the crosslinker. The oxidising agents may be dissolved in a solvent.

The polymer precursor and/or multivalent Lewis acid crosslinking agent may be degassed prior to polymerisation and/or crosslinking. Any solution used during polymerisation and/or crosslinking may also be degassed. Degassing may be important for radical polymerisation. Polymerisation may also use living polymerisation methods. Living polymerisation methods may include atomic transfer radical polymerisation (ATRP), reversible addition-fragmentation chain transfer (RAFT) and nitroxide-mediated polymerisation (NMP). The polymerisation may be carried out at a variety of temperatures depending on the type of polymer precursor. When solvents are used to form solutions of the polymer precursor and/or divalent Lewis acid crosslinking agent, the temperature of polymerisation may be determined by the boiling point of the solvent. The temperature of polymerisation may also be determined by the freezing point of the solvent. Therefore, the temperature of polymerisation may be carried out between a freezing point and a boiling point for a respective solvent system. For aqueous-based solvents, this may be between about 0° C. to about 100° C. For organic-based solvents, such as dimethylformamide, the temperature for polymerisation may be below 0° C. or higher than 100° C. In some embodiments polymerisation may be carried out at room temperature, for example at approximately 25° C. Mixing and/or polymerisation can, for example, be carried out for about 1, 2, 4, 6, 12, 18, 24 or greater than 24 hours.

The lamellar structure may be used in solution or it may be isolated. Isolation may include filtration, ultrafiltration and/or centrifugation. In an embodiment, the method further comprises the step of isolating the lamellar structure by filtration. Isolation may be followed by purification. Purification may include washing to remove any unreacted polymer precursor and/or multivalent Lew acid crosslinking agent. Deionized water may be used to wash the lamellar structure. Salts generated during the synthesis, such as during adjusting the pH of the polymer precursor solution, may also be removed during any washing steps. In an embodiment, the lamellar structure is washed and dried after filtration. Drying may be achieved by freeze drying, desiccation, a reduction in pressure and/or heating. When heating is used, a temperature below a glass transition temperature of the nanochains may be used. In an embodiment, the lamellar structure is dried at under vacuum. In some embodiments, the lamellar structure is dried under vacuum at a temperature above room temperature (i.e. above about 25° C.), for example, at about 80° C. In another embodiment, the lamellar structure is dried at about atmospheric pressure. In some embodiments, the lamellar structure is dried at about atmospheric pressure at a temperature above room temperature, e.g. a temperature of about 25° C. to about 200° C.

If the lamellar structure prepared by the method includes electrically conductive components, such as electrically conductive nanochains, it may be conductive. The polymer precursor and the crosslinking agent may be selected to provide a lamellar structure having a particular conductivity. In an embodiment, the polymer precursor is capable of polymerising to form an electrically conductive polymer. The polymer may be polyaniline in the form of pernigraniline.

The method may be performed in bulk or using continuous flow processes. However, in some embodiments, the method is performed on a surface, and this may form a surface coated with the lamellar structure. For example, polymerisation may be performed on a substrate. The lamellar structure coating on the surface may be in the form of a film, such as a thin film. If the lamellar structure is conductive, then the film may be conductive. The surface may also be conductive. Therefore, the method may be used to produce electrodes or other electrical components. The surface may or may not be treated prior to formation of the film. In an embodiment, the surface is not pre-treated prior to performing the method on the surface. Not having to pre-treat the surface can help to save time and reduce costs.

A fifth aspect of the invention provides a lamellar structure prepared using the method of the fourth aspect.

The lamellar structure of the fifth aspect may be otherwise as defined for the first or second aspect.

As will be apparent to a person skilled in the art, the electrically conductive or semi-conductive lamellar structures of the first aspect, second aspect or fifth aspect may have a variety of applications in electronic devices, including, but not limited to, batteries, capacitors, supercapacitors and electrodes.

In some embodiments, the lamellar structure of the first aspect, second aspect or fifth aspect is in the form of a free-standing film of its own structure. In some embodiments, films, powders, particles, suspensions and/or pastes of the electrically conductive or semi-conductive lamellar structure of the first aspect, second aspect or fifth aspect are used as electrode materials or separator materials for use in, for example, batteries, supercapacitors, fuel cells, separation equipment, sensors, electrolysers, displays and/or touch screens.

The lamellar structure of the first aspect, second aspect or fifth aspect may also be used as a feedstock to make other materials. For example, the lamellar structure may be converted into a carbonaceous material such as graphene, carbon and/or graphitic carbon. In such an example, the lamellar structure may be subjected to carbonisation such as thermolysis including pyrolysis. In an embodiment, a film, a powder, particles, a suspension and/or a paste of the lamellar structure is used as feedstock to produce graphene, or graphene derivatives containing non-carbon heteroatoms.

Because the architecture of the lamellar structure can have a high degree of order, the resulting material formed from the lamellar structure may also have an architecture with a high degree or order. Therefore, the use of the lamellar structure as a starting material may help to produce resulting carbonaceous materials with very specific properties. For example, if the lamellar structure has pernigraniline as the nanochains and the crosslinking agent is tungstic acid, the sheets are planar and may be converted into graphene and/or a N-doped graphene. Carbonisation may convert the pernigraniline into graphene sheets and/or nano ribbons, and the tungstic acid can then be leached out and recycled for later use in forming new lamellar structures. If the nanochains have heteroatoms such as nitrogen and sulphur, they may be converted into the respective heteroatom-doped carbonaceous material such as heteroatom-doped graphene. The nano ribbons may have specific dimensions, such as a width of about 100 to 1000 nm. When compared to traditional methods for generating graphene and/or nano ribbons, the use of the lamellar structure as a feed stock may be significantly less laborious. In some embodiments, the carbonaceous materials produced from the lamellar structure may be used in applications including batteries, supercapacitors, fuel cells, catalysts, electrolysers, sensors, displays, touch screens and/or heaters.

The lamellar structure may also be used to form metal catalysts. For example, when tungstic acid is used as the crosslinking agent, the lamellar structure may be treated to form carbon-supported tungsten carbide, oxide or nitride composites. Treatment of the lamellar structure to form, for example, tungsten carbide, may require temperatures of 700-800° C. instead of temperatures in excess of 1000° C. used in some prior art processes for preparing tungsten carbide. This may help to prove a more cost-effective way of producing tungsten carbide.

The lamellar structure used to form carbonaceous materials or metal catalysts as described above may be electrically conductive, electrically semi-conductive or electrically non-conductive.

### EXAMPLES

The present invention is further described below by reference to the following non-limiting Examples.

### Example 1

1. Methods

1.1 Chemicals

Aniline (>99.5%), ammonium metatungstate (99%), ammonium molybdite (99.8), ammonium persulphate (>98%), sulphuric acid (98%), Li₂SO₄ (99%), Na₂SO₄ (99%), K₂SO₄ (99%), Rb₂SO₄ (99.8%), Cs₂SO₄ (99.8%), MgSO₄ (99%), and KCl (99%) were purchased from Sigma Aldrich. All chemicals were used directly without further purification. Deionized water (18 MΩ) was supplied by a Millipore System.

1.2. Synthesis of Tungstic Acid-Linked Pernigraniline (TALP)

Aniline (372 mg) was dissolved in 0.2 M sulphuric acid aqueous solution (20 mL) to obtain solution A. Ammonium metatungstate (500 mg) and ammonium persulphate (1362 mg) were dissolved in deionized water (20 mL) to obtain solution B. The aqueous solutions A and B were mixed dropwise. The obtained solution was continuously stirred for 24 hours at room temperature (25° C.). The reaction was terminated by filtrating the solid product from the solution. The solid was washed thoroughly with deionized water, and dried under vacuum at 80° C. for 24 hours.

1.3. Synthesis of Molybdic Acid-Linked Pernigraniline. (MALP)

The preparation process was the same as the synthesis of TALP, except that the 500 mg ammonium metatungstate was replaced by 176 mg ammonium molybdate.

1.4. Synthesis of Tungstic Acid-Doped Emeraldine.

The emeraldine-type polyaniline was stirred in 100 mL of 0.1 M aqueous solution of ammonium metatungstate for 24 hours. The product was collected by filtration, washed by deionized water, and dried under vacuum at 80° C. for 24 hours.

1.5. Fabrication of Tungstic Acid-Linked Pernigraniline Film.

The film was produced in two methods. Method One: the substrate was placed on the surface of the mixed solution of A and B, and stabilized by the surface tension. Method Two: the mixed solution of A and B were dropped onto the surface of the substrate. The film growth was carried out at room temperature for different periods of time. The unreacted solution was removed; the as-produced film was rinsed thoroughly by deionized water. The TALP film electrode was dried under vacuum at 80° C. for 24 hours.

1.6. Electrochemical Measurement.

All the electrochemical measurements were carried out in a three-electrode cell with saturated calomel electrode (SCE) as reference electrode, and activated carbon pellet as counter electrode. The working electrode was the TALP film grown on stainless steel substrate. Cyclic voltammograms at different scan rates and galvanostatic charge/discharge at different current densities were conducted on a Biologic VSP potentiostat. The potential range for all tests was −0.2 V to 0.4 V versus SCE. 0.5 M aqueous solutions of Li₂SO₄, Na₂SO₄, K₂SO₄, Rb₂SO₄, Cs₂SO₄, MgSO₄ and KCl were used as neutral electrolytes.

1.7. Material Characterization and Instrumentation

Scanning electron microscopy (SEM) images were collected on a FEI Nova NanoSEM 450 field-emission scanning electron microscope at 5 kV. Transmission electron microscopy (TEM) and high-resolution TEM (HR-TEM) analysis was conducted on a FEI Tecnai G2 F20 transmission electron microscope operated at 200 kV. Energy-dispersive spectroscopy (EDS) elemental mapping images were scanned using a JEOL JEM-ARM200F transmission electron microscope at 200 kV. Powder X-ray diffraction (XRD) was conducted using a PANalytical Xpert materials research diffractometer, with a Cu Kα irradiation source (λ=1.54056 Å) at a scan rate of per min. Thin film XRD was performed on a Bruker D8 Thin-Film XRD with rotating anode. Atomic force microscopy (AFM) was carried out using a Bruker Dimension ICON scanning probe microscope in tapping mode. X-ray photoelectron spectroscopy (XPS) was recorded on a Thermo ESCALAB250Xi X-ray photoelectron spectrometer. Raman spectroscopy was collected using a Renishaw inVia 2 Raman Microscope with 532 nm (green) diode laser. Thin film conductivity was measured using a Jandal wafer probing four point probe system combining a multiposition probe stand and a RM3 test unit with 1 mm probe spacing. N2 cryo-adsorption was analysed using a Micromeritics Tristar 3030. Brunauer-Emmett-Teller theory was used to derive the specific surface area from the adsorption isotherm. Differential scanning calorimetry (DSC) and thermogravimetric analysis (TGA) were both performed on a TA instrument Q20/Q5000. Laser ablation inductively coupled plasma mass spectrometry (ICP-MS) was collected on a PerkinElmer quadrapole Nexion 300D ICPMS with an ESI-NewWave NWR213 Laser Ablation accessory.

1.8. Calculation of Volumetric Capacitance of TALP Film Electrode

The TALP film is dense, nonporous and has flat surface. This allows the straightforward estimation of the volume based on the film thickness and diameter. The density of the film was derived from the film volume and the film mass. The film mass was averaged from 10 pieces of TALP film with the same thickness.

Cyclic voltammetry (CV) and galvanostatic charge/discharge (GCD) were used to measure the capacitance of TALP film. The volumetric capacitance was calculated using the following formula:

$$\begin{matrix}CV method \text{:} {C}_{V} = \frac{{C}_{f}}{{V}_{f}} = \frac{\int IdE}{{V}_{f} v E} & ( 1 ) \\ GCD method \text{:} {C}_{V} = \frac{It}{{V}_{f} E} & ( 2 )\end{matrix}$$

where Cᵥ: volumetric capacitance (F cm⁻³), C_{f}: measured capacitance of one TALP film (F), V_{f}: TALP film volume (cm⁻³), I: current (A), E: potential range (V), v: potential scan rate (mV s⁻¹), t: discharge time (s).

2. Self-Assembly Using Molecular Acid and Pernigraniline Base

The synthesis of layered conductive TALP involves the in-situ making use of conjugated pernigraniline base (PB), the fully oxidized form of polyaniline, which becomes electronically conducting when ‘doped’ with acid. The tetrahedral tungstic acid (TA, H₂WO₄) as a ‘dopant’ forms the hydrogen bond with PB that organises the intraplanar structural order, and acts as the interplanar spacer with its two W═O bonds directing the out-of-plane stacking order. As a result, the ‘doped’ conjugated unit and the tetrahedral linker work in concert to form a layered, conducting 2D supramolecular material.

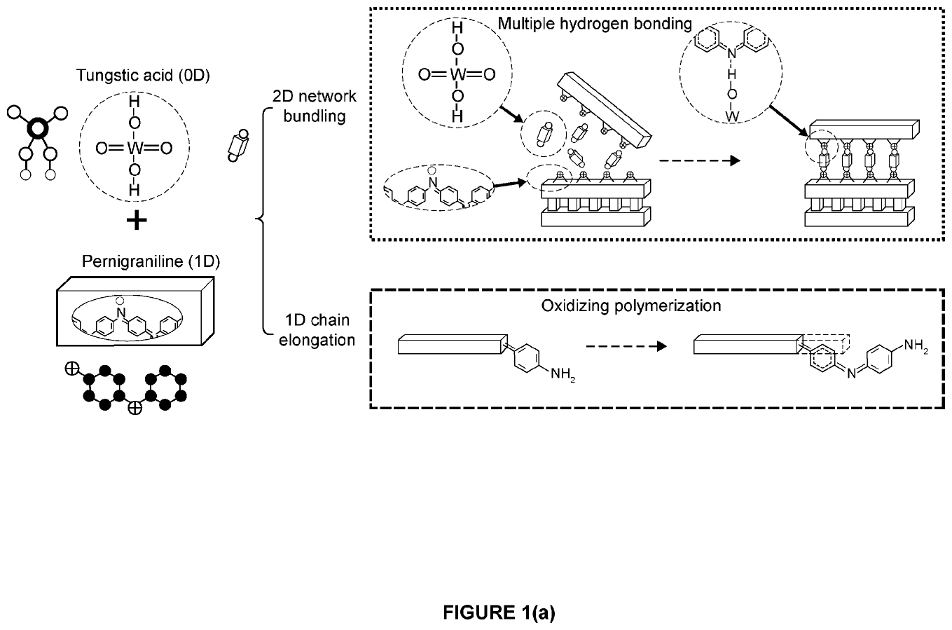

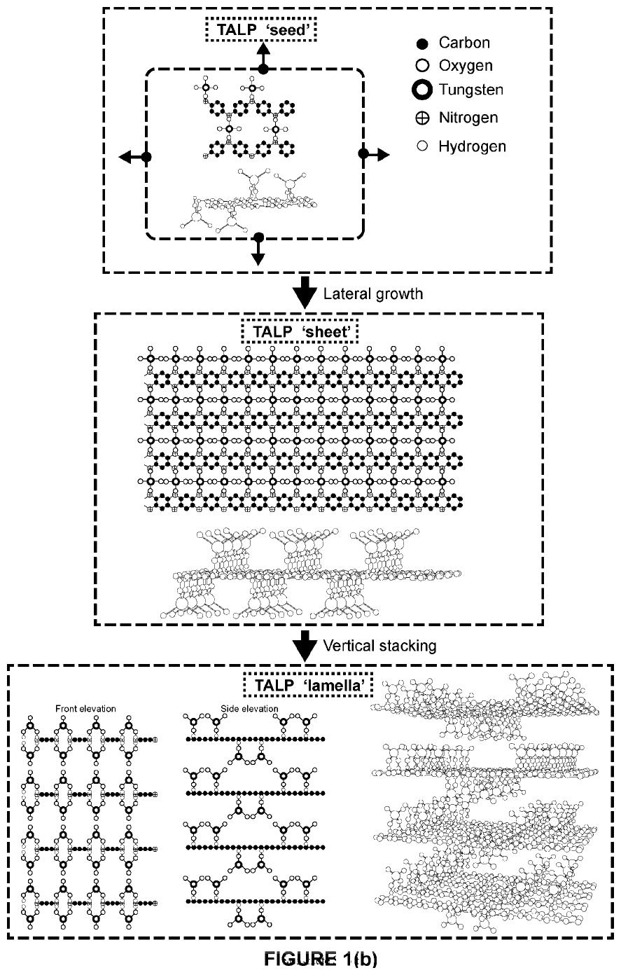

The synthesis concept is schematized in FIG. 1. The hydrogen bonding as a typical noncovalent interaction provides a general route toward the self-assembly of well-defined supramolecular structures. The TALP is chemically like a 2D pernigraniline ‘salt’, which is composed of the self-assembled hydrogen-bonded TA and PB (FIG. 1a). The in-plane growth of TALP is on two directions: along with and normal to the axis of the pernigraniline chain. The spontaneous hydrogen bonding between pernigraniline and tungstic acid drives the formation of the 2D network. Meanwhile the oxidation polymerization continuously elongate the 1D pernigraniline chains to create more bundling sites to expand the 2D network. The two H atoms on molecular tungstic acid are the key to ‘glue’ the PB chains into a 2D network; a monoacid molecule can only serve as a dopant, rather a linker. In this regard, the pH of the reaction solution should be kept below the pKa of the TA molecule. A single hydrogen bond is not strong enough to stabilize the long polymeric chains; the multiple hydrogen bonds should form between PB chains and TA molecules. In this approach, the TA molecule with two H-termini serves as OD mortar that links the complementary imines (═N—) on the two adjacent PB chains (1D bricks), thereby directing the lateral self-assembly by the arrayed multiple side-chain hydrogen bonds (>N⋅⋅⋅H—O—WO₂—O-H⋅⋅⋅N<). This structural model will require a stoichiometric ratio of 1:2 between W and N. The growth of the PB chains generates new imine sites for hydrogen bonding, giving rise to the elongated 2D network. The ‘2D network bundling’ and the ‘1 D chain elongation’ processes should take place simultaneously to maintain in-plane structural order. The lamellar assembly may occur either at the very early ‘seed’ stage, or during the lateral growth period (FIG. 1b). The lamellar assembly is primarily driven by the tendency of minimizing surface energy via the interlayer noncovalent forces. The two W═O bonds, that are out of the 2D plane, act as the interlayer pillar to stabilize the stacked structure (FIG. 1b). The interlayer space is thus dependent on the orientation of the hydrogen bond, the geometry of the tungstic acid, and the noncovalent interactions between the nearby layers.

A one-pot synthesis was deployed to fabricate TALP. The starting materials contained aniline, ammonium persulfate (as oxidant for polymerisation of aniline), ammonium metatungstate (AMT, turns to tungstic acid upon acidification), and sulphuric acid. The TALP reported in this study was prepared at room temperature with a molar ratio of AMT:aniline at 1:2. Other molecular acids containing two H-termini are possible linkers to assemble the TALP-like structures. Ammonium molybdate was used to assess if the TALP-like structure can be produced with molybdic acid linkers.

3. Structural Analysis

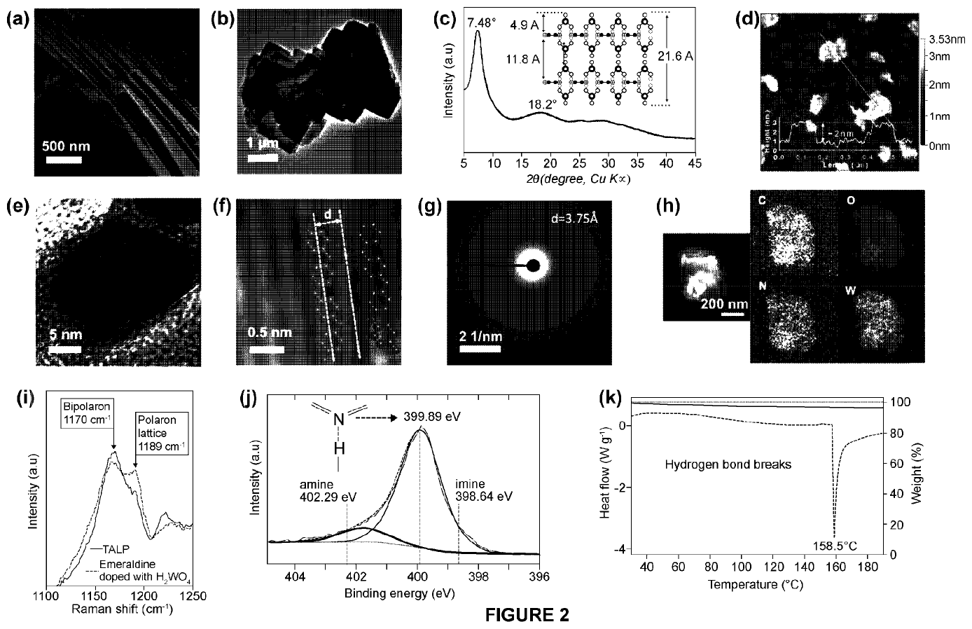

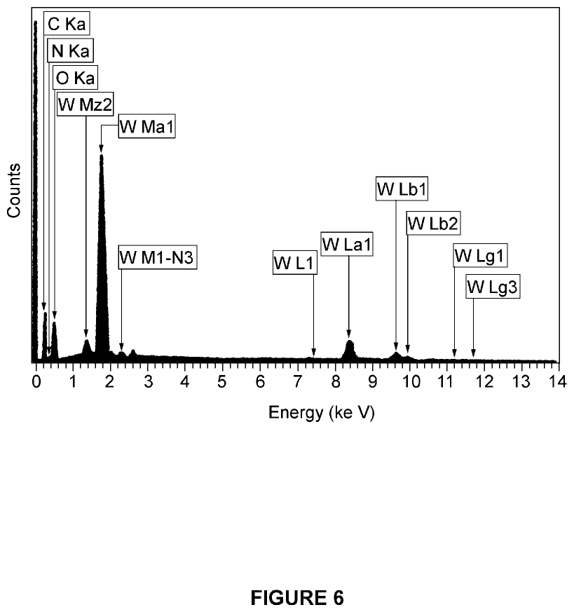

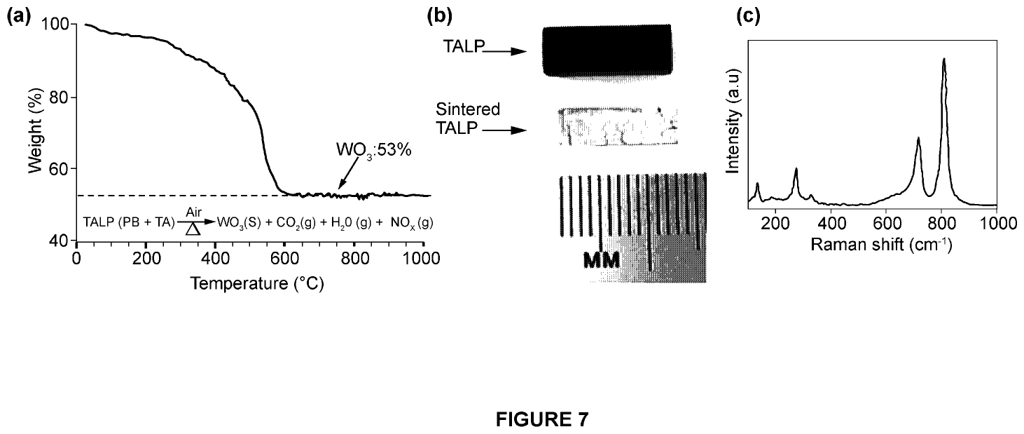

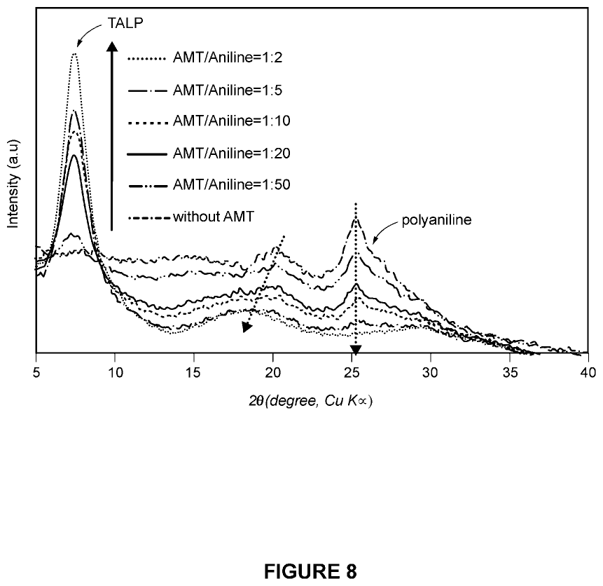

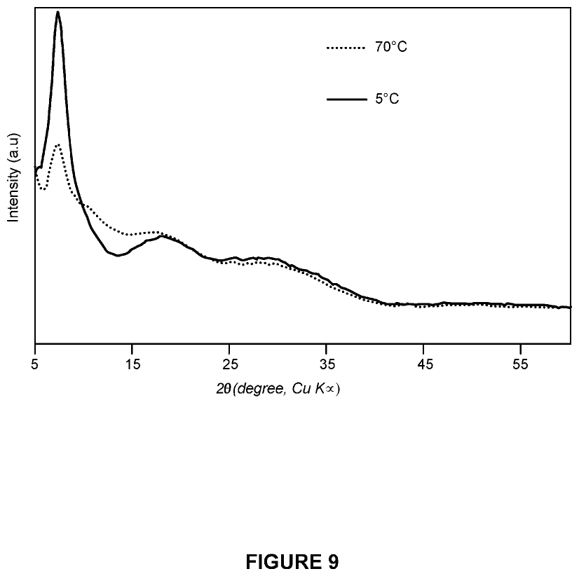

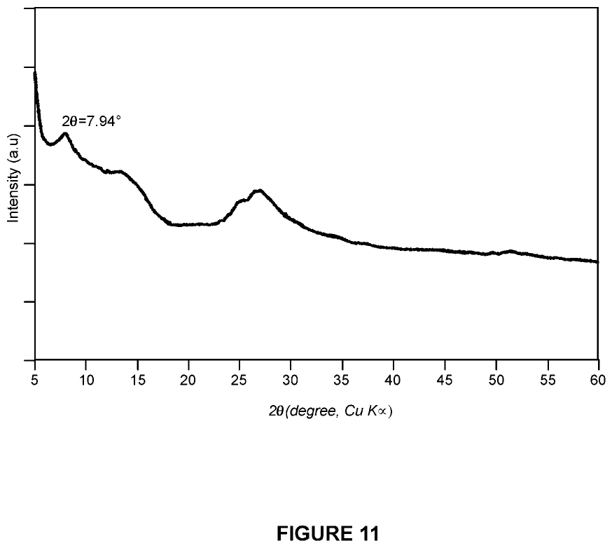

The energy-dispersive spectroscopy (EDS) survey detected C, N, O and W (FIG. 6). The atomic ratios of W:N in the as-made TALP were 1:2.04 and 1:1.96, according to thermogravimetric analysis (TGA) (FIG. 7) and laser ablation inductively coupled plasma mass spectrometry (ICP-MS), respectively. In FIG. 7a, the atomic content of W in original TALP was calculated from the weight percentage (53 wt %) of the residue, which was determined as WO₃. The atomic content of N was estimated from the weight percentage of pernigraniline base (PB), which was derived by subtracting the weight percentage of tungstic acid (TA) according to the W content. In FIG. 7b, the colour changed from dark blue to yellow, indicating the phase transformation from TALP to WO₃. FIG. 7c also shows the Raman spectrum for the TALP monolith sintered in air at 600° C. for 3 hours showing the WO₃ phase. These values are close to the starting molar ratio of AMT:aniline, and are consistent with the above predicted molar ratio of W:N. Electron microscopy analysis recognised the layered morphology of the as-made TALP (FIG. 2a and FIG. 2b). As shown in FIG. 2a, the layered morphology is noticeable. X-ray diffraction (XRD) patterns of the TALP showed a remarkable (001) peak at 2θ=7.48° (FIG. 2c), indicating a lamellar period of ˜11.8 Å. Another diffused peak at 2θ=18.2° correlates with the distance (˜4.9 Å) between the O in the W═O bond and the basal plane (FIG. 2c). The lamellar orderness for TALP diminished as the AMT:aniline molar ratio reduced from 1:2 (FIG. 8). The (001) peak intensity enhanced stepwise as the molar ratio of AMT:aniline increased gradually from 1:50 to 1:2. This phenomenon suggests that the multiple hydrogen bonds at most imine groups, if not all, are key to the structural integrity. Besides, increasing the temperature will decrease the structure orderness (FIG. 9). The high-temperature synthesis resulted in less ordered c-axis stacking. The TALP powders were easily delaminated by conducting ultrasonication-assisted exfoliation in a variety of solvents, such as acetone, ethanol, water, etc. (FIG. 10). The exfoliated sheets showed an average thickness of ˜2 nm by using atomic force microscopy (AFM) (FIG. 2d), suggesting that these sheets are primarily bi-layered (FIG. 2c). This synthesis concept was extended to molybdic acid-linked pernigraniline (called ‘MALP’). The XRD pattern confirmed the emergence of the (001) peak at 2θ=7.94° showing the layered structure (FIG. 11). The low-angle diffraction peak located at 7.94° suggests the emergence of the layered structure in MALP, despite the residue PANi structure as observed from the peaks near 25°.

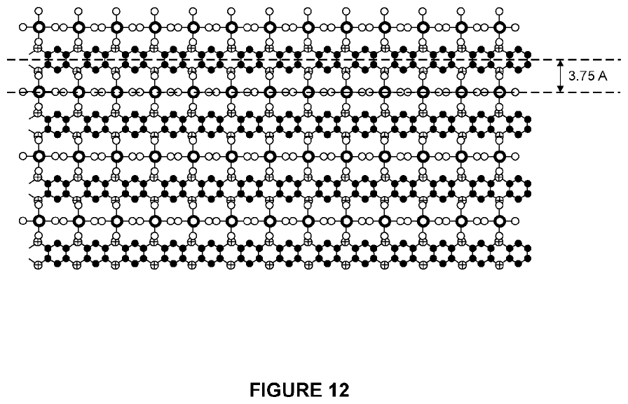

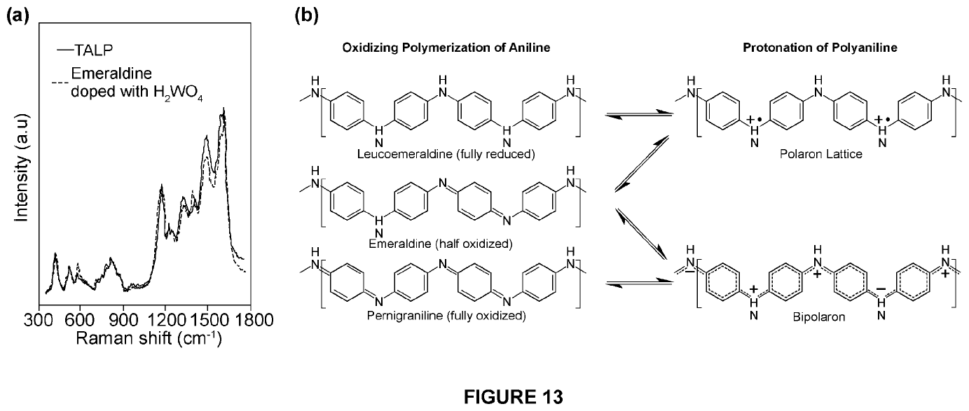

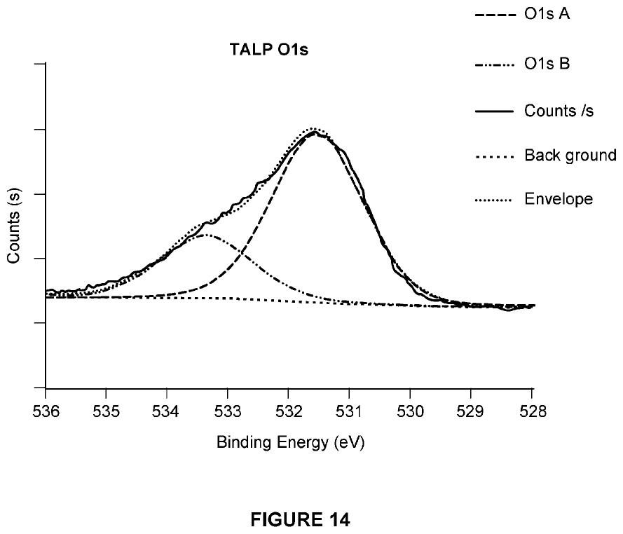

The proposed in-plane structure consisting of bundled chains of PB that were cross-linked by TA was confirmed by using high-resolution transmission electron microscopy (HR-TEM) and selected area electron diffraction (SAED) (FIGS. 2e-g, and FIG. 12). In FIG. 12, the distance between the centre line of the linear chain of pernigraniline base (PB) and that of the tungstic acid (TA) is estimated to be 3.75 Å, in accordance with the HRTEM and SAED results in FIGS. 2e-g. EDS elemental mapping illustrated the uniform distribution of C and N atoms in PB, and the O and W atoms in TA, in a TALP particle (FIG. 2h). This nanoscale homogeneity reveals the well-distributed binding between PB and TA throughout the TALP particles. Raman spectra in (FIG. 2i) showed the only bipolaron peak at 1170 cm⁻¹ in TALP, which is exclusively assigned to pernigraniline (FIG. 13 and Table 1) in TALP. FIG. 13a shows Raman spectra of the TALP and the emeraldine doped with tungstic acid, while FIG. 13b illustrates the structure of polyaniline at its different states of oxidation and the corresponding protonated structure. According to this structure evolution mechanism, the protonated pernigraniline contains only bipolaron, whereas the protonated emeraldine consists of both polaron lattice and bipolaron. In contrast, the emeraldine doped with tungstic acid presents both polaron lattice and bipolaron peaks. The X-ray photoelectron spectroscopy (XPS) N1s and O1s regions provide evidence to identify the hydrogen bond between TA and PB. The O1s region presents the two peaks of W═O and W—OH, indicating the molecular status of tungstic acid in TALP (FIG. 14). In FIG. 14, O1s A represents the W═O bond and O1s B represents the W—OH bond. The electrophilic H atoms on TA interact with the electron negative N atoms on PB. The binding energy between N and H relates to the strength of the interaction. The N1s profile of TALP in FIG. 2j showed the main N1s peak at 399.89 eV, suggesting that the N—H bond in TALP was weaker that the amine structure (=NH—, 402.29 eV), but stronger than the imine group (=N—, 398.64 eV). This mild shift in binding energy indicates that the N atoms on the 1D PB chains form hydrogen bonds with the OD TA linkers. The energy of hydrogen bonds is typically between 5 and 30 kJ mol⁻¹, and is weaker than the covalent bonds or ionic bonds. The differential scanning calorimetry (DSC) profile in FIG. 2k revealed the endothermic peak at 158.5° C. that is correlated with the dissociation of hydrogen bonds. The relevant weight loss at the peak temperature was negligible meaning this endothermic reaction was not caused by moisture removal. The TALP is chemically self-organised via the hydrogen bonds (—N⋅⋅⋅H—O—) between PB and TA. On account of both TALP and MALP, the method produces a new class of 2D supramolecular layered structure composed of acid-linked pernigraniline (ALP) based on hydrogen bond, which is unlike the present known 2D organic-based materials.

TABLE 1
Raman assignment

| | | Standard | | | Emeraldine | |
|---|---|---|---|---|---|---|
| Peak | | Peak | | | doped with | |
| (cm⁻¹) | | (cm⁻¹) | | TALP | H₂WO₄ | Assignment |
| 1620 | (s) | 1623 | (sh) | Yes | Yes | v(C~C)B |
| 1595 | (s) | 1585/1595 (s) | | Yes | Yes | v(C═C)B |
| 1566 | (w) | 1566 | (sh) | Yes | No | v(C—C)Q in |
| | | | | | | pernigraniline |
| 1512 | (sh) | 1512 | (sh) | No | Yes | N—H bending |
| | | | | | | (SQ) |
| 1493 | (s) | 1490/1493 | | Yes | Yes | v(C═N)Q; or |
| | | | | | | partially |
| | | | | | | charged imines |
| 1478 | (sh) | 1475 | | Yes | Yes | v(C═N)Q |
| 1412 | (m) | 1412 | (w) | Yes | Yes | Phz |
| 1338 | (m) | 1350 (s)/1335 | | Yes | Yes | v(C~N⁺) of |
| | | | | | | delocalized |
| | | | | | | polaronic |
| | | | | | | structure/ |
| | | | | | | bipolarons |
| 1326 | (m) | 1326 (s)/1330 | | Yes | No | v(C~N⁺) |
| 1317 | (w) | 1315 | | No | Yes | Polaron lattice |
| 1300 | (sh) | 1295/1300 | | No | Yes | Isolated |
| | | | | | | polarons |
| 1253 | (m) | 1260 | (m) | Yes | Yes | v(C—N)B |
| 1221 | (m) | 1221 | (w) | Yes | No | v(C—N)Q |
| 1191 | (s) | 1191 | | No | Yes | Polaron lattice |
| 1170 | (s) | 1170 | (s) | Yes | Yes | (C—H)SQ?; |
| | | | | | | Bipolaron |
| 876 | (w) | 874 | (w) | Yes | Yes | C—N—C |
| | | | | | | wagging (o.p); |
| | | | | | | B ring |
| | | | | | | deformation |
| | | | | | | (i.p) in |
| | | | | | | polarons and |
| | | | | | | bipolarons |
| 811 | (m) | 810 | (w) | Yes | Yes | B ring |
| | | | | | | deformation |
| 715 | (w) | 718 | (w) | Yes | Yes | Amine |
| | | | | | | deformation in |
| | | | | | | bipolaronic |
| | | | | | | form |
| 642 | (w) | 656 | (w) | Yes | Yes | Tungstate |
| | | | | | | anion |
| 576 | (m) | 575 | (w) | Yes | Yes | Phenoxazine- |
| | | | | | | type units |
| 522 | (m) | 520 | (w) | Yes | Yes | Ring |
| | | | | | | deformation |
| | | | | | | (o.p) |
| 418 | (m/s) | 417 | (w) | Yes | Yes | Ring |
| | | | | | | deformation |
| | | | | | | (o.p) |

4. Fabrication of TALP Film Electrode

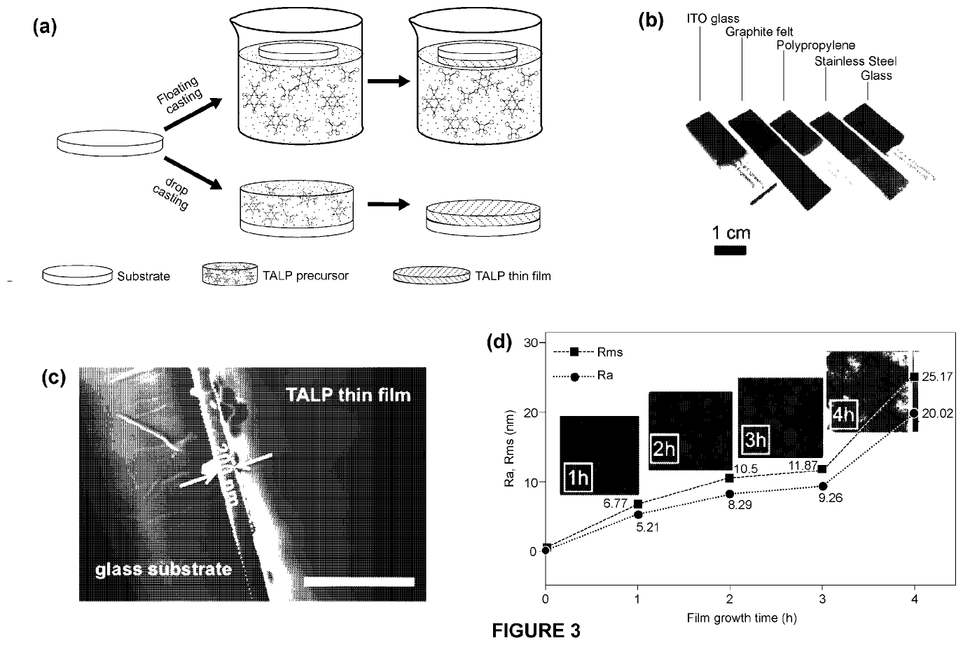

Calendaring powdery active materials with binders has been commonly used to increase the electrode density. However, in such a way, the packing density of the electrodes is less than the true density of the materials, because the electrode volume is partially unused owing to the electrochemically inert binding agents, as well as the interparticle voids. To maximize the volumetric performance, it is necessary to develop binder-free, dense electrodes. A facile liquid/solid interface-directed mechanism was used to grow the binder-free TALP thin films on various substrates (FIG. 3a). The substrate can either float at the surface of the precursor solution, or be covered by the solution. The interface self-assembly of TALP was successful on many different substrates, including stainless steel, polypropylene, glass, metal oxide (e.g. indium-doped tin oxide (ITO)) and graphite (FIG. 3b). The density of the film was in a range of 2 to 2.5 g cm⁻³ depending on the film growth condition, which is nearly two folds of emeraldine salt (˜1.3 g cm⁻³), or condensed graphene. The average electronic conductivity of the TALP film with a thickness of 200 nm (FIG. 3c) on glass was estimated to be 6.05 S cm⁻¹ by using a four-probe method (Table 2), on the same order of magnitude as emeraldine salt. Pernigraniline base is the highest oxidation state of polyaniline, and is insulating at undoped status. Tungstic acid acted as an acid dopant in TALP to delocalize the π electrons, in addition to its core role as the structural ‘mortar’. The conductivity of TALP is comparable with that of 1D graphene nanoribbons (ca. 3 to 5 S cm⁻¹), reflecting its usability as electrode materials without additional conducting agents. The surface roughness of the TALP film increased as a function of growth time (FIG. 3d). The nanoscale roughness showed the rather flat characteristics of the self-assembled TALP film.

TABLE 2
Four-point conductivity measurement on a 200-nm
film supported by a glass substrate

| Points | 1 | 2 | 3 | 4 | 5 | 6 | 7 | 8 | 9 |
|---|---|---|---|---|---|---|---|---|---|
| Sheet | 8.238 | 8.608 | 8.382 | 7.991 | 8.309 | 8.242 | 8.236 | 8.099 | 8.307 |
| resis- | | | | | | | | | |
| tance | | | | | | | | | |
| (R_{S}, | | | | | | | | | |
| kΩ/sq) | | | | | | | | | |

Average sheet resistance (Rs): 8.269 kΩ/sq

Average resistivity (R): 0.16538 Ω cm

Average conductivity (S): 6.05 S cm⁻¹

Calculation formulas are following:

$$R = {R}_{S} t$$

$$S = \frac{1}{R}$$

where S: conductivity (S cm⁻¹), R_{S}: sheet resistance (Ω/sq), R: resistivity (Ω cm), t: film thickness (cm).

5. Electrochemical Analysis of TALP Film Electrodes

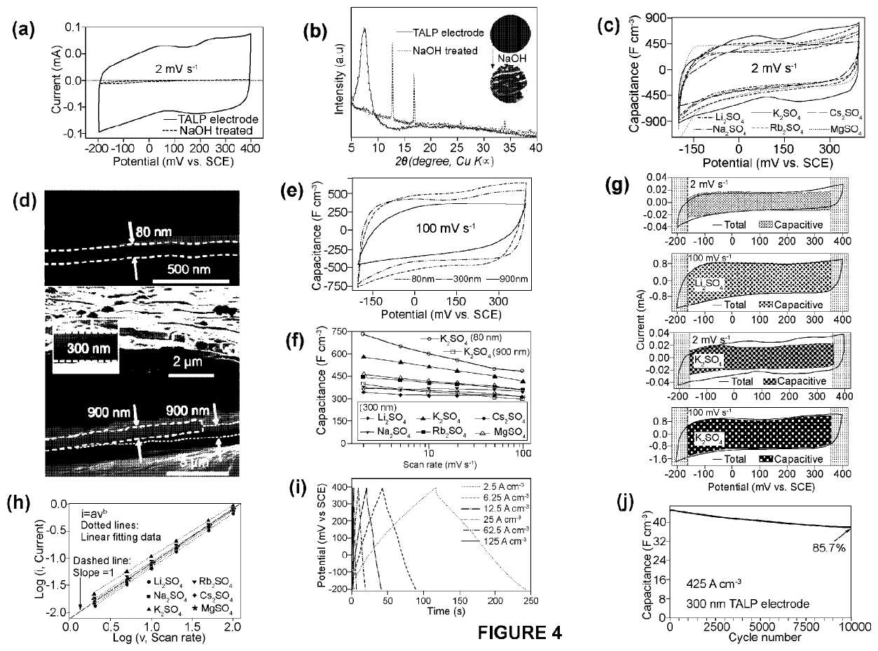

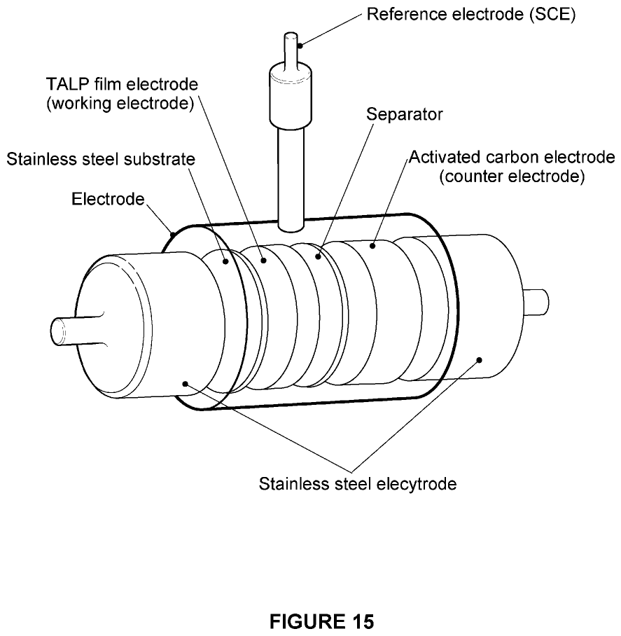

The pseudocapacitive behavior of the layered TALP structure was assessed using a standard three-electrode setup in which saturated calomel electrode and high-surface-area activated carbon served as the reference and auxiliary electrodes, respectively (FIG. 15). The electrochemical property of TALP was first explored using cyclic voltammetry (CV) in 0.5 M K₂SO₄, in comparison with a NaOH-treated TALP electrode (FIG. 4a). The substrate can either float at the surface of the precursor solution, or be covered by the solution. The rectangular CV profile for TALP showed prominent current response. In contrast, the NaOH-treated TALP electrode showed nearly zero current response. The XRD patterns in FIG. 4b revealed the destruction of layered structure after NaOH treatment. NaOH leached the TA linkers and destructed the layered structure that is responsible for charge storage. The pseudocapacitive performance of TALP was thus correlated with its conductive 2D layered structure. The rectangular CV shape of TALP was distinguished from the typical potential-dependent redox peaks for pernigraniline base, indicating the capacitive intercalation mechanism for TALP.

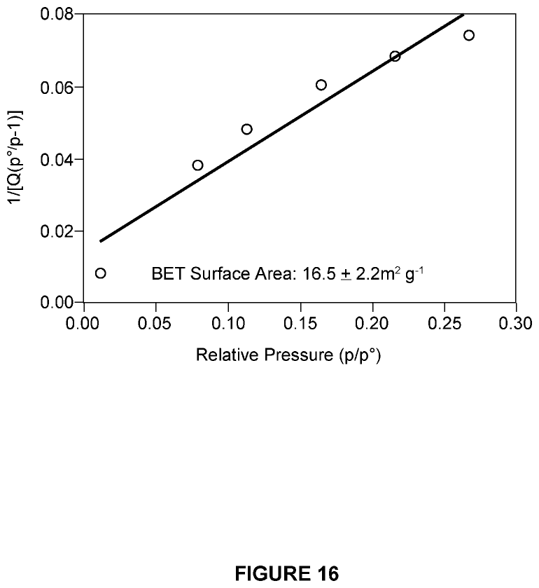

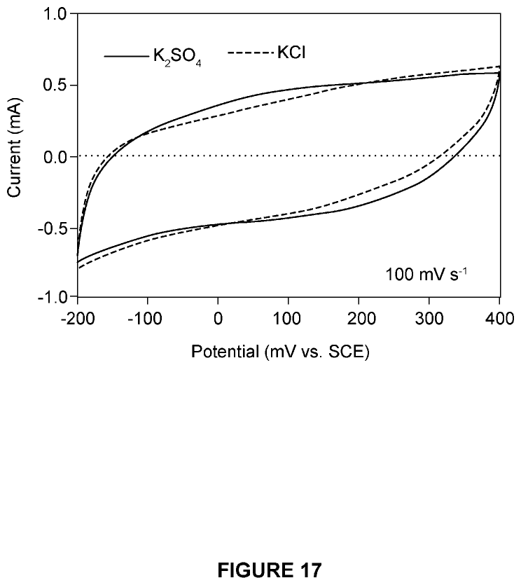

To unravel whether the cations or anions intercalated the TALP layers, the volumetric capacitances of TALP electrodes with the same thickness (300 nm) were compared in 0.5 M Li₂SO₄, Na₂SO₄, K₂SO₄, Rb₂SO₄, Cs₂SO₄, and MgSO₄ solutions, in which the cation sizes were different whereas the anion size was constant (FIG. 4c). The quasi-rectangular shape implies the capacitive nature of the charge propagation. The volume of the TALP electrode was calculated on the basis of the film thickness and the film diameter (1 cm). The electrodes demonstrated different values, all of which were in excess of 300 F cm⁻³ in these solutions, suggesting that it was the cation intercalation. High capacitive performance is typically from materials with high surface area. However, the surface area of TALP is as low as 16.5 m²g⁻¹ (FIG. 16). If the surface-controlled processes were the only operation mechanism, capacitance for TALP would be expected small. However, as noted above, the ion intercalation capacitance can exceed the capacitance contributed solely from the surfaces. CV was also collected with K₂SO₄ and KCl electrolytes. The shape and current of these two CVs were nearly the same despite the different anion radii, suggesting that it was cation intercalation that dominated (FIG. 17). The nearly identical shapes indicate the intercalation was related to the cation, rather than the anions with different ionic radius.

The TALP film electrodes with three different thicknesses (80, 300 and 900 nm) were fabricated (FIG. 4d). The effect of film thickness on the cation intercalation was studied using CV (FIG. 4e). The CVs showed the rectangular shape at high scan rate at 100 mV s⁻¹, which was preserved even for the 900 nm electrode, highlighting the fast kinetics of ion transport in TALP. The dependence of the capacitance on the scan rate in various solutions is plotted in FIG. 4f. Films with different thicknesses were compared. The volumetric capacitances obtained with 0.5 M Li₂SO₄, Na₂SO₄, K₂SO₄, Rb₂SO₄, Cs₂SO₄, and MgSO₄ solutions for the 300 nm TALP electrodes were 343, 372, 580, 448, 370, and 461 F cm⁻³ at 2 mV s⁻¹, respectively, suggesting the promising potential of TALP for volumetric charge storage in neutral electrolytes. The best capacitance performance at 732 F cm⁻³ was obtained with the 80 nm TALP electrode in 0.5 M K₂SO₄ electrolyte at 2 mV s⁻¹. Despite the larger thickness, the volumetric capacitance of the 900 nm electrode in K₂SO₄ was more than 300 F cm⁻³ at scan rates ranging from 2 to 50 mV s⁻¹, and was 296 F cm⁻³ at 100 mV s⁻¹. Capacitance retention at 100 mV s⁻¹ was found to be greater than 90% in Li₂SO₄ and Na₂SO₄, and within a range of 70-80% in the rest electrolytes, illustrating the capability of TALP for fast charging/discharging operation.

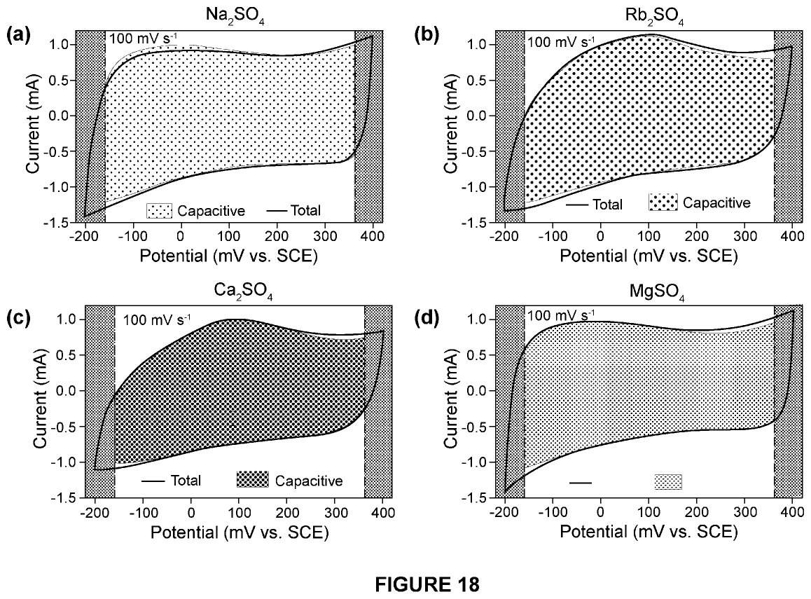

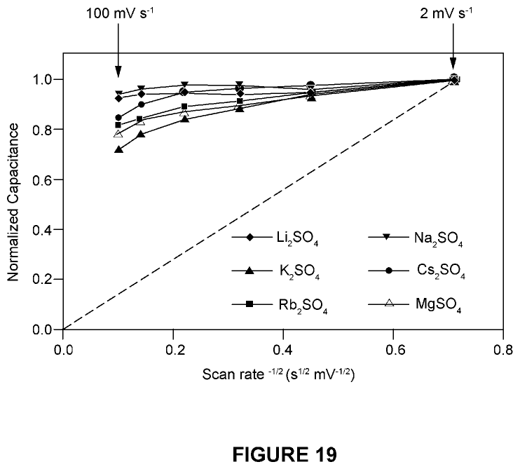

To shed light on the pseudocapacitive nature of intercalation into TALP, the capacitive current was derived and compared with the total current (FIG. 4g). The shaded area in FIG. 4g highlights the capacitive contribution, which dominates the total charge storage. The contribution of the capacitive current was nearly 100% of the total current, and was at the least 70% in a particular condition (K₂SO₄, 2 mV s⁻¹). The absence of potential-dependent redox peaks in the CV profiles ruled out the contribution from the surface faradaic reaction of polyaniline that is known as doping mechanism. On account of the small surface area, the large portion of capacitive current can be attributed to be primarily from pseudocapacitive intercalation and not from electric-double layer capacitance. Similar behaviour was observed with other neutral electrolytes (FIG. 18). The rate-limiting step in the pseudocapacitive intercalation was established on the basis of the relationship between the normalized capacitance and the root square of scan rate (v^{-1/2}, FIG. 19). FIG. 19, shows that the relationship separates the semi-infinite diffusion-controlled current from capacitive-controlled current, where the dashed diagonal line represents the semi-infinite diffusion. The normalized capacitance is virtually independent of v^{-1/2} in various electrolytes, indicating the capacitive feature of the intercalation process. According to the power-law relationship of the capacitance with the scan rate (FIG. 4h), the intercalation kinetics was determined to be on the same order as surface-controlled process (b=1), and thus fast. The slope b=1 in FIG. 4h indicates the surface-controlled process for fast electrode kinetics. The fast intercalation was attributed to be mainly resulted from the large basal spacing (11.8 A), which is nearly 2.5-3.5 times of the hydrated cation sizes (3.3 to 4.8 Å), as well as the good electronic conductivity. This capacitive intercalation was validated by the linear relationship between the electrode potential and charging/discharging time (FIG. 4i). In FIG. 4i, the applied current was normalized to the film volume. Under harsh cycling conditions at extremely large current density of 425 A cm⁻³ for 10,000 cycles, the TALP electrode exhibited rather stable performance with the capacitance retention found to be 85.7% (FIG. 4j). The partial loss of performance might be linked with the accumulated impedance at such high current draining rate over long-period cycling test.

6. Minimal Lattice Expansion with TALP Electrode

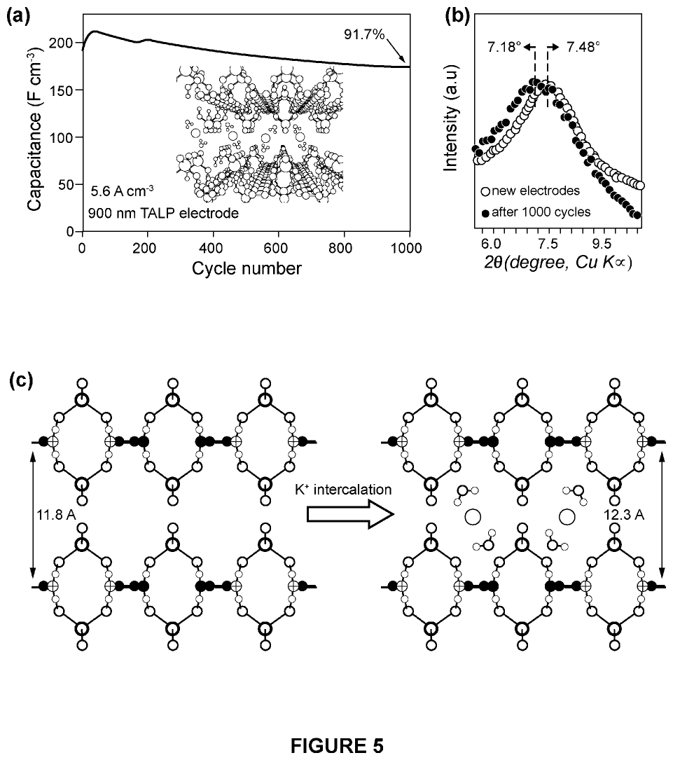

Hydrated ion intercalation causes the lattice expansion along the c-axis direction of layered materials. Relaxing such volume change can improve the material integrity and stability. Materials with large ion-accessible channels could empower swift ion movement while possibly suffering less lattice expansion upon repeated intercalation/de-intercalation cycles. Thus it is interesting to find out the lattice expansion behaviour of TALP electrode, considering its large basal spacing. A higher amount of K⁺ can intercalate into TALP as reflected by the larger value of capacitance (FIG. 40. As a result, the lattice change could be expected remarkable with K⁺ relative to other cations. We collected the XRD pattern of the 900 nm TALP electrode after cycling test in 0.5 M K₂SO₄ at a current density of 5.6 A cm⁻³ for 1,000 cycles (FIG. 5a). The ex-situ XRD result is compared in FIG. 5b with the fresh electrode before cycling. The spent TALP electrode was recovered from the cell and washed with deionized water after 1000 cycles. After cycling test, the intensity of the (001) peak for the spent electrode was almost the same as the new one, indicating that the orderness of the layered structure was mostly preserved. The interlayer spacing was revealed to be expanding upon the intercalation, but to a marginal extent. The expansion of the spacing between the TALP layers was only 0.5 Å, 4.2% of the original value (FIG. 5c). Such minimal lattice expansion was only observed with proton intercalation in previous report (Acerce, M. et al., Nat. Nanotechnol. 10, 313-318, 2015). This unusual behaviour is attributed to the fact that the basal spacing of TALP (11.8 Å) is about 3.5 times of the hydrated K⁺ ion (3.3 Å) (FIG. 5c). Therefore the relatively large space in the interplanar channel allows the ionic intercalant to diffuse freely without causing substantial expansion. The measurable lattice expansion, albeit minimal, confirmed that the high volumetric capacitances of TALP in neutral salt solutions were originated from the ion intercalation, despite the low surface area.

7. Conclusion

A general and effective approach for the bottom-up synthesis of two-dimensional layered supramolecular structures is demonstrated, by using the multiple arrayed hydrogen bonds between conjugated pernigraniline base and tungstic acid (TALP). TALP is unique in that it opens up new avenues for the predesignable synthesis of 2D supramolecular materials through using acid molecules as both linkers and dopants. For each TALP-like material, precise control over the conjugated skeleton, the shape of the molecule, and the functional-group orientation is key to electrochemical performances. The interesting pseudocapacitive ion intercalation properties of the 2D TALP structure may be used for a variety of alkali and alkali-earth cations, including abundant Mg and Na, which can make it an appealing electrode material for future beyond-Li energy storage devices, such as batteries and hybrid metal-ion capacitors. This disclosure can be used to develop unique 2D materials to achieve promising applications in many areas, including electrochemical sensors, electrochemical desalination, and field-effect transistors.

### Example 2

1. Methods

1.1 TALP Preparation:

Solution A of 0.15M H₂SO₄ and 0.1M aniline mixing solution was prepared by diluting 7.5 mL 2M H₂SO₄ into 100 mL in a jacketed reaction beaker and adding 0.93 mL aniline solution into the beaker subsequently. A circulating water bath was used to control the reacting temperature around 5° C. and solution A was stirring by magnetic stirrer continuously.

Solution B of 0.2M ammonium persulfate (APS) and 0.05M ammonium metatunagstate (AMT,) mixing solution was prepared by weighting 4.56 g APS and 1.365 g AMT respectively and adding 100 mL deionized water into beaker subsequently. Afterwards, mixing solution was stirring using a magnetic stirrer until transparent solution B was obtained.

Solution B was added into solution A by a syringe pump and the temperature was controlled to around 5° C. by circulating water bath under continuous stirring for 48 h. TALP sample was collected by vacuum filtration and then followed by vacuum drying at 60° C. overnight.

1.2 TALP Thin-Film Preparation:

The preparation method is similar to the one of TALP powder, but solution A and B were mixed first in a beaker, then stainless steel discs were covered on top of the solution for 45 min. The obtained electrode was washed by DI water and dried under vacuum at 80° C. overnight.

1.3 Polyaniline Preparation:

The PANI preparation progress is similar to the one of TALP, but AMT is not added into the system.

Solution A of 0.15M H₂SO₄ and 0.1M aniline mixing solution was prepared by diluting 7.5 mL 2M H₂SO₄ into 100 mL in a jacketed reaction beaker and adding 0.93 mL aniline solution into the beaker subsequently. A circulating water bath was used to control the reacting temperature around 5° C. and solution A was stirring by magnetic stirrer continuously.

Solution B of 0.2M ammonium persulfate (APS) solution was prepared by weighting 4.56 g APS and adding 100 mL deionized water into beaker. Afterwards, mixing solution was stirring by magnetic stirrer until transparent solution B was obtained.

Solution B was added into solution A by a syringe pump and the temperature was controlled to around 5° C. by circulating water bath under continuous stirring for 48 h, after which a PANI sample was collected by vacuum filtration and then followed by vacuum drying at 60° C. overnight.

1.4 Structural Characterizations:

The XRD patterns of TALP powders and electrode films were tested by X-ray diffraction system with Cu Kα radiation at a step rate of 2° min⁻¹. The UV-vis results were obtained from UVvis3600, Shimadzu. The morphology of TALP samples and thickness of electrode film were measured by a field-emission scanning electron microscope (FE-SEM). The composition and valence state of nitrogen for TALP samples and electrode films were verified by X-ray photoelectron spectrometer (XPS). The solvent exchange phenomenon was unraveled by Nuclear magnetic resonance (NMR).

1.5 Electrochemical Measurements:

The electrochemical performances were investigated by assembling 2016 coin cells in a glove box filled with pure argon gas. The working electrode slurry was prepared by dispersing pure TALP sample, carbon black and poly (vinyldene fluoride) (PVDF) binder in N-methyl-2-pyrrolidone (NMP) solvent with a weight ratio of 80:10:10. After drying at 80° C. under vacuum overnight, the electrode film was punched into 10 mm in diameter discs and pressed in a sheeter under 10 MPa. Later, lithium plate was used as counter electrode while polypropylene membrane was employed as separator. 1M LiPF₆ in ethylene carbonate (EC)/ethyl methyl carbonate (EMC) solution was used as the electrolyte. Galvanostatic charge/discharge cycling (GCD) was measured by a multi-channel battery testing system. Cyclic voltammetry (CV) and electrochemical impedance spectroscopy (EIS) were measured by a potentiostat. The GCD was tested in the voltage range of 1.5-4.5V versus Li/Li⁺ and the specific gravimetric/volumetric capacity is based on the whole electrode weight/volume. The CV result was recorded with scan rate ranging from 0.1 to 1 mV s⁻¹. The EIS was performed at open circuit voltage (OCV) with an amplitude of 5 mV, and the frequency ranging from 10 mHz to 200 kHz.

2. Results and Discussion

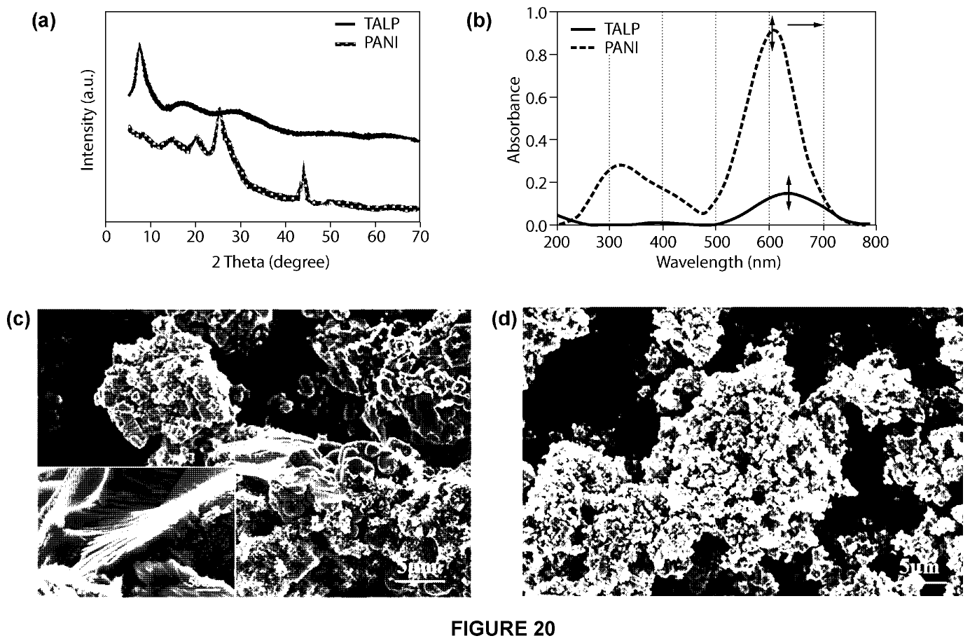

The structures of TALP are different from PANI as shown in FIG. 20, which indicates the mechanism of two materials for energy storage may be discrepant. The X-ray diffraction (XRD) patterns of TALP and PANI are shown in FIG. 20a, which reveal obvious differences between TALP and PANI powders. A notable peak at low degree)(20=7.47° is detected in TALP powder which indicates the distance of two carbon atoms in adjacent layers is 2.99 Å. Compared to the pattern of PANI powder, the peaks in TALP powder which are related to PANI decrease or disappear. Besides, UV-vis spectroscopy of TALP and PANI were measured to characterize the intrinsic structure of two materials. For two materials, the UV-vis results show two absorption peaks in FIG. 20b, and the strong absorption peak around 650 nm in TALP is shifted compared with that in PANI implying higher oxidation state of polyaniline chains in TALP which plays a key role in determining the property of PANI.

Moreover, the peak around 320 nm in PANI is assigned to π·π transition in the benzenoid structure, but the absorption peak vanishes in TALP. Further, the scanning electron microscopy (SEM) of TALP and PANI powders revealed the differences in structure. In 20c-d, a typical 2D layered structure with stacked morphology in TALP powder is shown. However, the PANI powder shows irregular morphology which is composed of random particles.

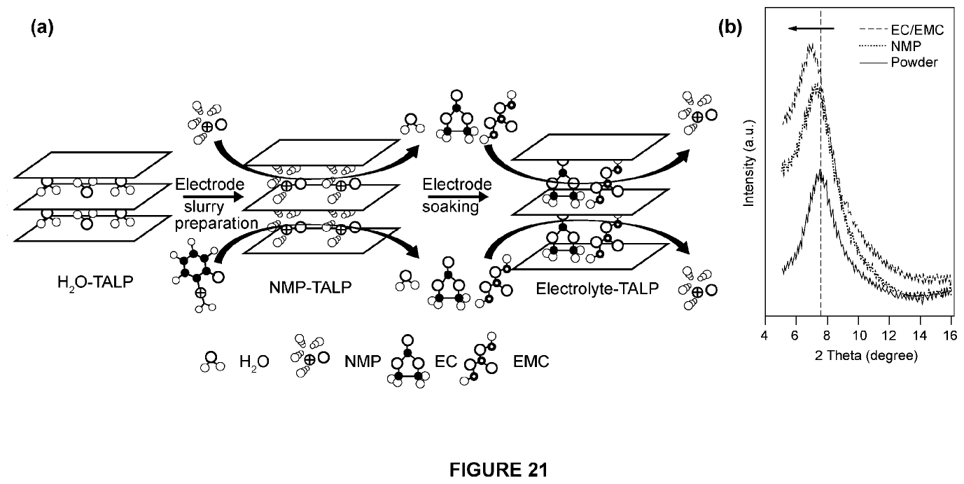

Solvent exchange phenomenon, which would affect the function, mechanism and performance is found in TALP during both electrode slurry preparation and electrolyte soaking steps as illustrated in FIG. 21a. Here, NMP was firstly introduced as solvent during electrode slurry preparation to remove H₂O while EC and EMC are added as solvents to exchange out NMP and to act as electrolytes. From the XRD patterns in FIG. 21b, it is obvious that the interlayer spacing of H₂O-TALP, NMP-TALP and electrolyte-TALP expanded along with the two processes. Owing to the tungstic acid linked between layers by hydrogen bonding or weak electrostatic interactions, the function of tungstic acid is to support the layers resulting to ion channels which are employed in ion diffusion. Besides, the vacuum drying may not be able to remove the trapped moisture between layers and some of the remaining moisture may still maintain in the TALP by weak hydrogen bonding or electrostatic interactions. Herein, after mixing TALP powder with carbon black, PVDF and NMP when preparing the electrode slurry, NMP solvents diffused into the layers by differential concentration and occupied the sites of interlayer moisture. In the meantime, the layer distance was enlarged and the first-step in solvent exchange was accomplished. Subsequently, during the process of cell assembly, after soaking in the electrolyte, NMP residual was replaced by EC/EMC solvent and the interlayer spacing of TALP was further expanded by the similar mechanism and that is the second-step solvent exchange. Thanks to the large layer spacing of the 2D-layered structure, the large size organic molecules are able to diffuse into the inter layer. Additionally, with the nanoconfined solvents working as interlayer electrolyte, the rate performance of TALP would be enhanced.

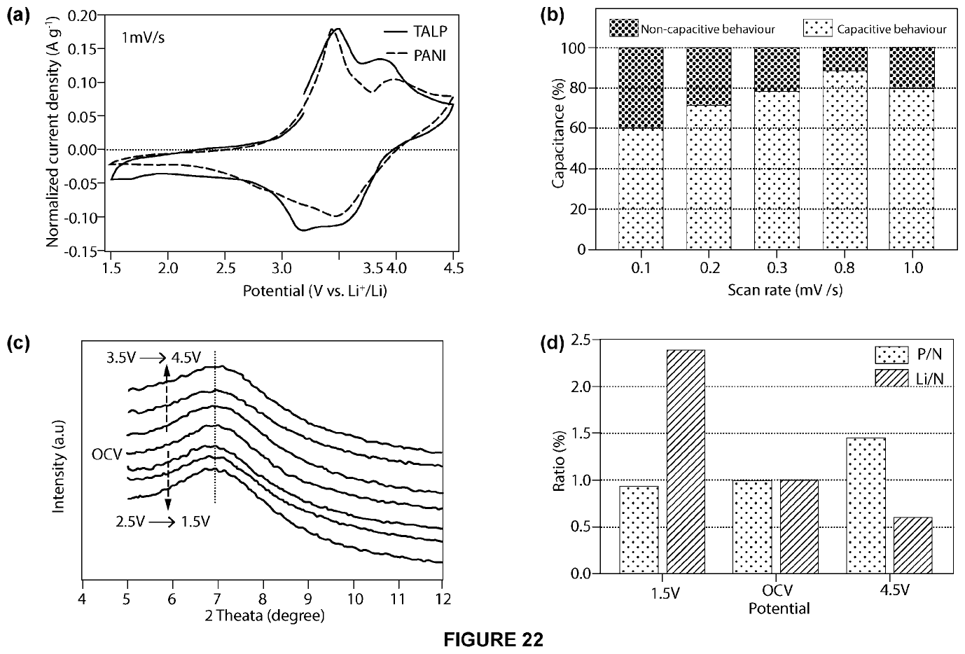

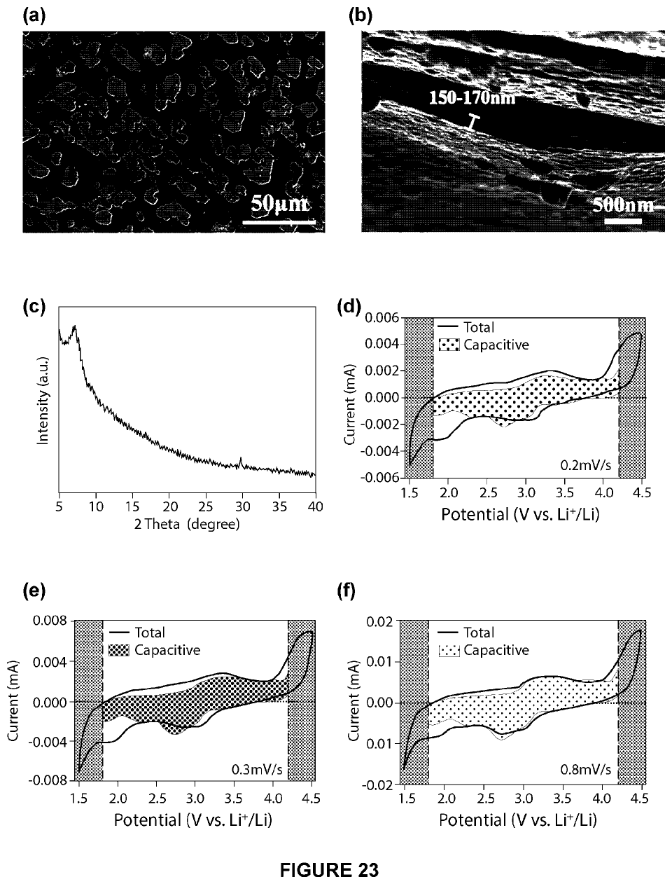

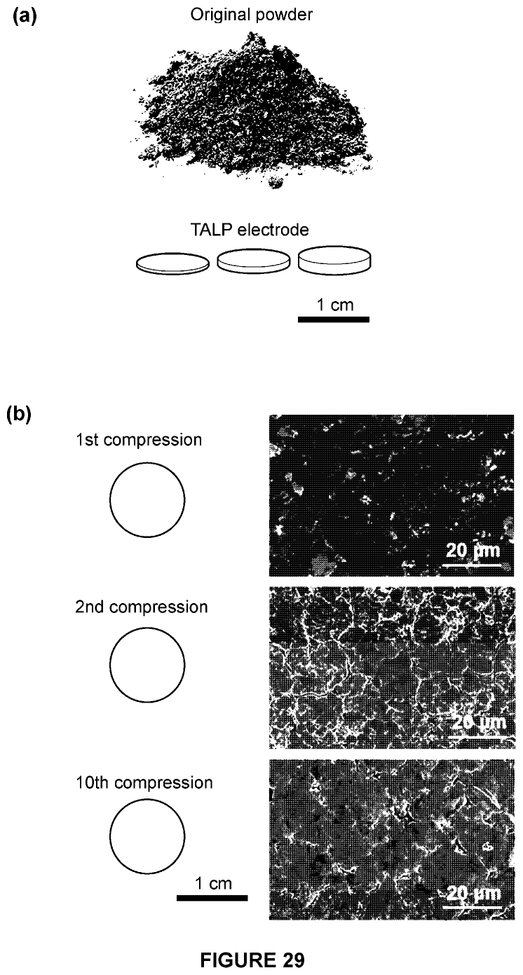

Through the process of solvent exchange, the interlayer spacing of TALP was expanded to permit cation/anion intercalation between layers. Despite this, the nanoconfined electrolyte results in more surface-like ion diffusion and charge transfer during ion intercalation as mentioned. Hence, TALP was applied onto a LIC cathode as fast ion intercalation/de-intercalation host. To understand the mechanism of TALP, cyclic voltammetry profiles of TALP and PANI at a scan rate of 1 mV/s in a voltage range of 1.5˜4.5V are shown in FIG. 22a. The shape of CV curve for TALP is close to that of PANI, which means the charge storage behaviour of TALP is similar to that of PANI. Moreover, a TALP thin film electrode with a thickness of 150-170 nm, as shown in FIG. 23a-c, was used to calculate the current distribution from CV at different scan rates. The thickness of a TALP cathode was measured under SEM and FIG. 29 shows the cross-section image of TALP cathode. The thickness of the electrode ranges from 5-6.5 m, resulting in the volume ranges from 3.927-5.105*10⁻⁴ cm³ and the density of 3.389 g cm⁻³. Contrarily, the density of a PANI electrode is 1.698 g cm⁻³.

It is clear that the total charge storage in TALP can be separated into two parts, capacitive and non-capacitive behaviour, as presented in FIG. 23a-c. A TALP thin-film electrode with a thickness of 150-170 nm was prepared as shown in FIG. 21a-b. The XRD pattern in FIG. 23c indicates that the obtained thin-film has a similar layered structure as a TALP powder. The differentiation of the capacity contribution from capacitive and non-capacitive process with the CV scan rate of 0.2 mV s-1, 0.3 mV s-1 and 0.8 mV s-1 is presented in FIG. 23d-f. The capacitive behaviour part increases along with the increasing scan rate and occupies the most part of charge storage, which is shown in FIG. 22b. XRD patterns of several electrodes charged/discharged to different potentials during 1^{st} cycle is shown in FIG. 22c, which reveals no obvious peak shift with the potential ranging from 1.5 to 4.5V, demonstrating that after the electrolyte solvent swells into the layer channel, neither layer expansion nor phase change occurred during the charge/discharge. Moreover, the X-ray photoelectron spectroscopy (XPS) measurement of TALP electrodes at potential of 1.5V, 4.5V and OCV at the initial cycle was performed to quantify the amount of Li, N and P elements, in which P element comes from PF₆⁻, Li is from Li⁺ and N is located in TALP. The XPS result under OCV when both the ratio of Li/N and P/N are 1:1 confirms that Li⁺ and PF₆⁻ are able to dissolve into the interlayer after the cell was assembled. Nevertheless, it is clear that with a rise of potential from 1.5V to 4.5V, the ratio of P/N increases while the one of Li/N decreases, that is, the anion and cation exchange during charge/discharge process at the range of OCV.

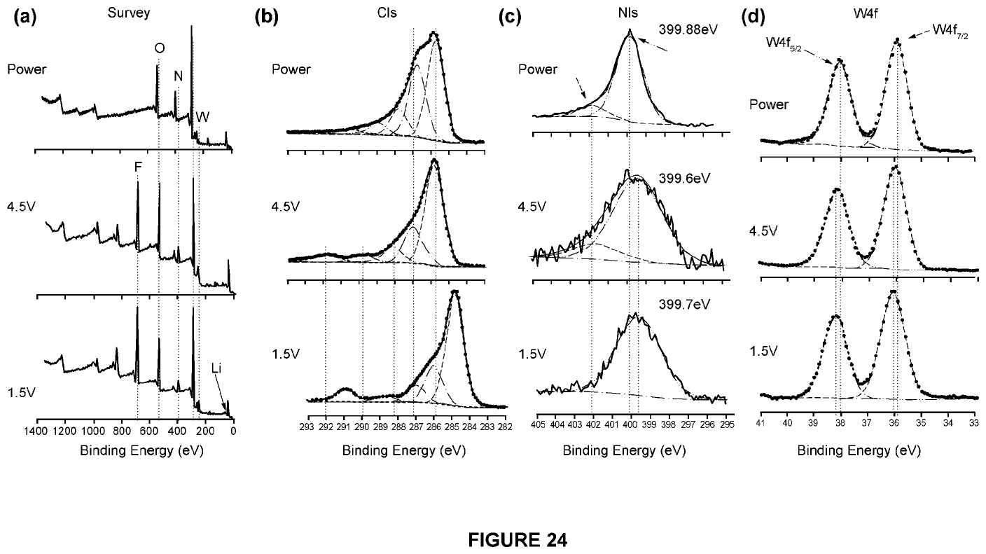

In addition, from the results of XPS shown in FIG. 24 comparing TALP powder with TALP electrodes at upper and lower cut-off voltage, the C1s and W4f profiles show no obvious differences. However, the N1s profiles of a TALP powder and a TALP electrode at potential of 4.5V can be decomposed into two components. The peaks at lower binding energy of 399.88 eV and 399.6 eV, respectively, are assigned to nitrogen atoms linked to tungstic acid, while the peaks at higher binding energy around 402 eV are related to the radical cationic nitrogen atoms. Differently, the peak at higher energy side no longer exists when the TALP electrode was discharged to 1.5V. It is assumed that the positive charge of nitrogen atoms was neutralized by electrons during discharge, which resulted in the reduction of active sites for anions absorption, leading to the irreversible capacity in charge process. Herein, the mechanism of TALP for energy storage can be divided in two parts, capacitive ion intercalation/de-intercalation and non-capacitive polyaniline redox reaction, among which the stored energy can be mainly attributed to capacitive behaviour.

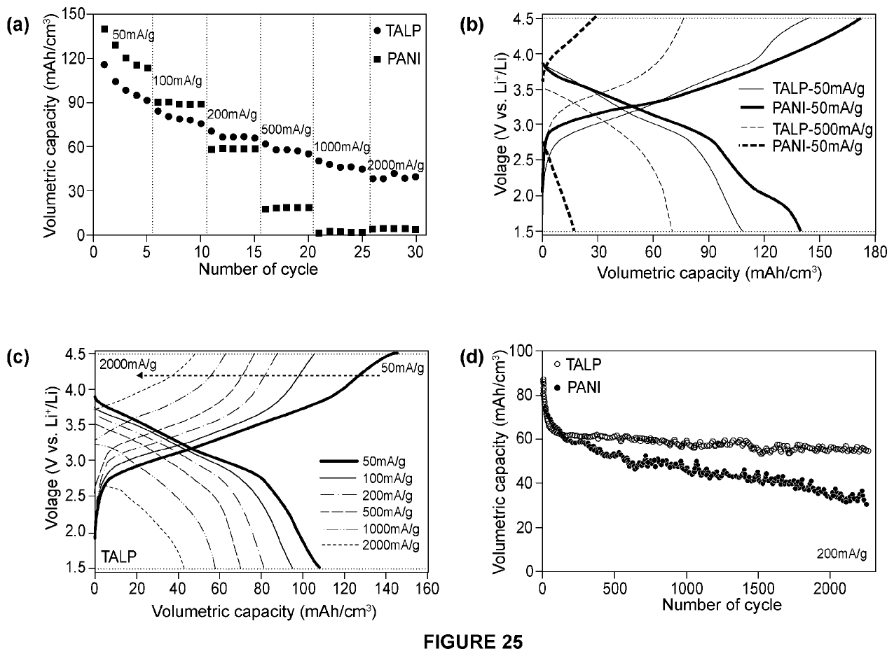

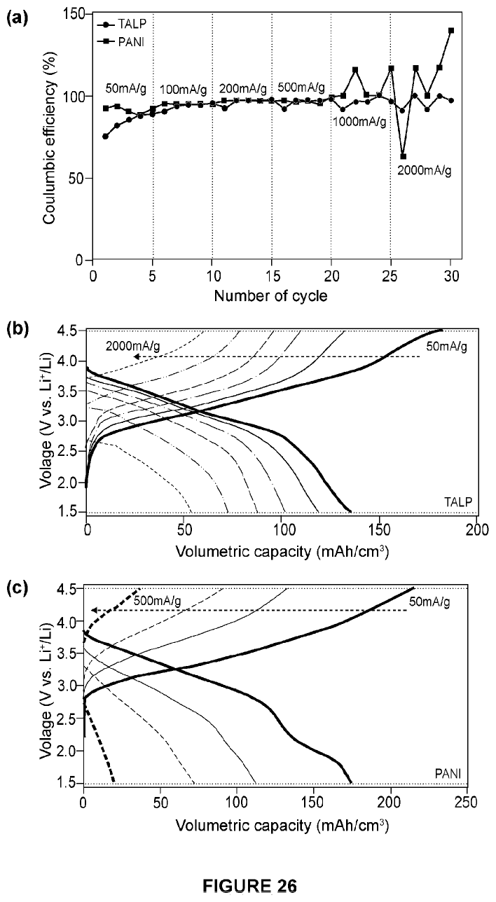

Because of the spontaneous twisting of PANI chains in the formation process, the active site of PANI is almost covered, leading to the inferior electrochemical performance. Conversely, the 2D layer architecture design of TALP eliminates the limitation with the straightened PANI chains, large interlayer spacing and the nanoconfined electrolyte, more active sites are exposed to the electrolyte and the ion diffusion path is shortened, which is benefit for ion fast intercalation/de-intercalation. Besides, the electronic conductivity is enhanced as well. Regarding these advantages, solvated TALP could be in favour of acting as a rapid and fast ion intercalation host. Herein, electrochemical capability of a series of TALP and PANI electrodes were tested under the same situation, which is shown in FIG. 25. Comparing the rate performance of TALP and PANI, although the volumetric capacity under small current density is lower than PANI, TALP demonstrates superior fast charge/discharge ability to PANI. At a high current density of 2000 mA/g, TALP electrode outputs a high volumetric capacity of ˜38 mAh/cm², while the one of PANI is lower than 5 mAh/cm². Also, TALP shows higher stability than PANI as presented in FIG. 26. The columbic efficiency of TALP and PANI under the current density ranges from 50 mA/g to 2000 mA/g is shown in FIG. 26a and FIG. 26b-c shows the GCD curves of TALP and PANI at various current densities. As shown in FIG. 25b, the shape of galvanostatic charge/discharge (GCD) curve of a TALP electrode is similar to that of a PANI electrode, except there is a turning point at around 3.8V of the charge curve, which may be due to the intercalation of PF₆⁻, corresponding to the results of CV studies.

Apart from the rate capability, TALP also shows more stable cyclibility as shown in FIG. 25d. TALP electrode remains 63.3% capacity after 2000th cycle at a current density of 200 mA/g, while only 39.7% retention of PANI electrode after the same operation.

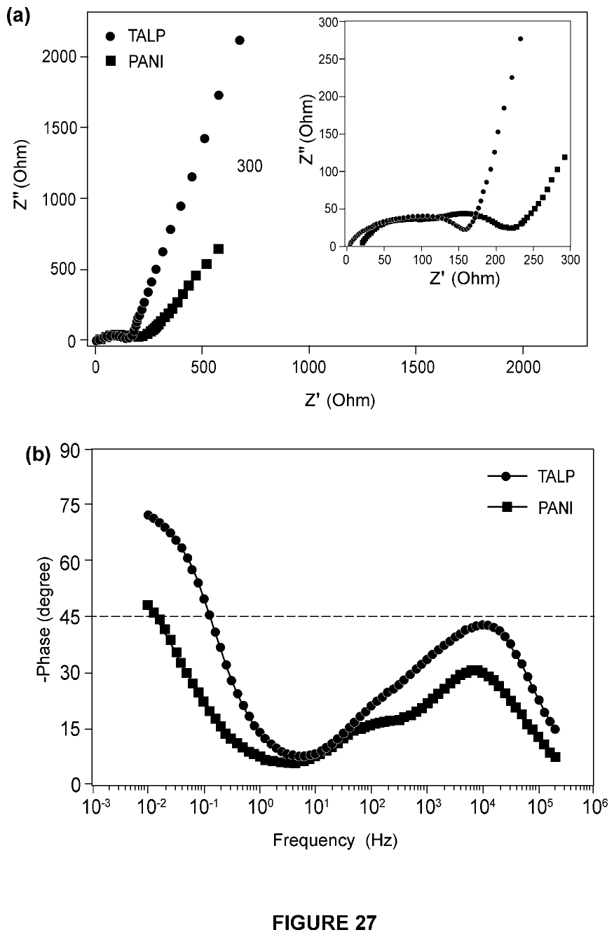

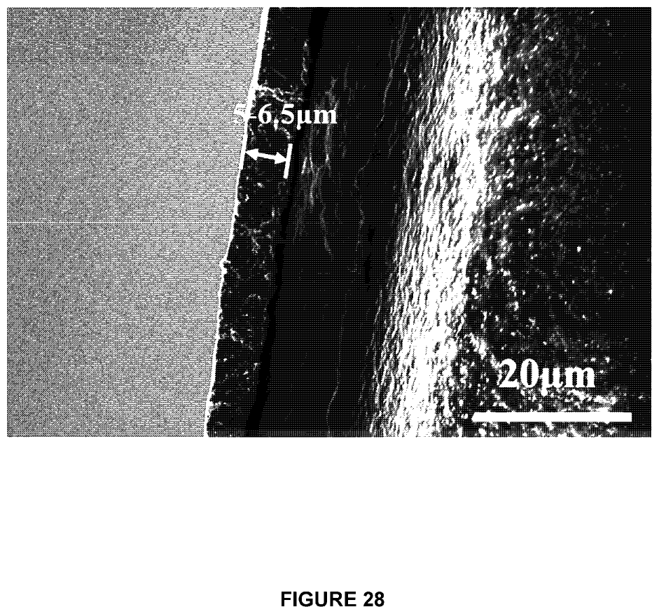

The electrochemical impedance spectroscopy (EIS) of TALP and PANI electrodes were also investigated which is related to the intrinsic resistance of active materials, charge-transfer resistance and ionic diffusion in different frequency regions. As shown in FIG. 27a, it can be seen that the resistances of a TALP electrode for three frequency regions are much lower than those of PANI electrode, indicating that the solvated 2D layer structure can significantly enhance the electronic conductivity and greatly decrease resistances of both charge transfer and ionic diffusion step during charge/discharge process.

Moreover, the phase angle plays a key role in judging the capacitive behaviour of a capacitor. In FIG. 27b, the phase angle of TALP electrode is −72.3°, while the one of a PANI electrode is −48.2°, suggesting that the TALP electrode exhibits more capacitor performance than the PANI electrode since the phase angle for an ideal capacitor is −90°. Meanwhile, the capacitor response frequency (f₀) at a phase angle of −45° for PANI and TALP electrodes were 0.016 Hz and 0.126 Hz, resulting in the calculated relaxation time (To) of 62.5 ms and 7.9 ms, respectively. Here, T₀ represents the minimum time for discharging all the energy from the device with efficiency higher than 50%. Compared with PANI, TALP showed smaller resistance and better frequency response, reflecting TALP has superior fast charge/discharge capability, which is in high agreement with the rate performance.

3. Conclusion

In summary, a facile method to synthesize 2D layered structure TALP is employed. The unique characteristics of TALP, such as the linear chain of polyaniline, the layer channels and the nanoconfined fluids, exposing more active sites to electrolyte with surface-like ion diffusion and charge transfer properties, may be suitable for efficient charge storage as supercapacitor cathode electrode. TALP electrodes exhibits significantly superior rate performance and excellent cycling stability, comparing with pure polyaniline prepared by the same method. Notably, the charge storage mechanisms of TALP electrodes, including solvent exchange and anion/cation exchange, are confirmed evidently, which are superior to the record principles for energy storage. The remarkable electrochemical performance of TALP suggests that TALP can be used as either cathodes or even anodes in the new generation of energy storage.

### Example 3

For this Example, TALP was prepared using similar methods to Examples 1 and 2.

1. Structural Variations of TALP

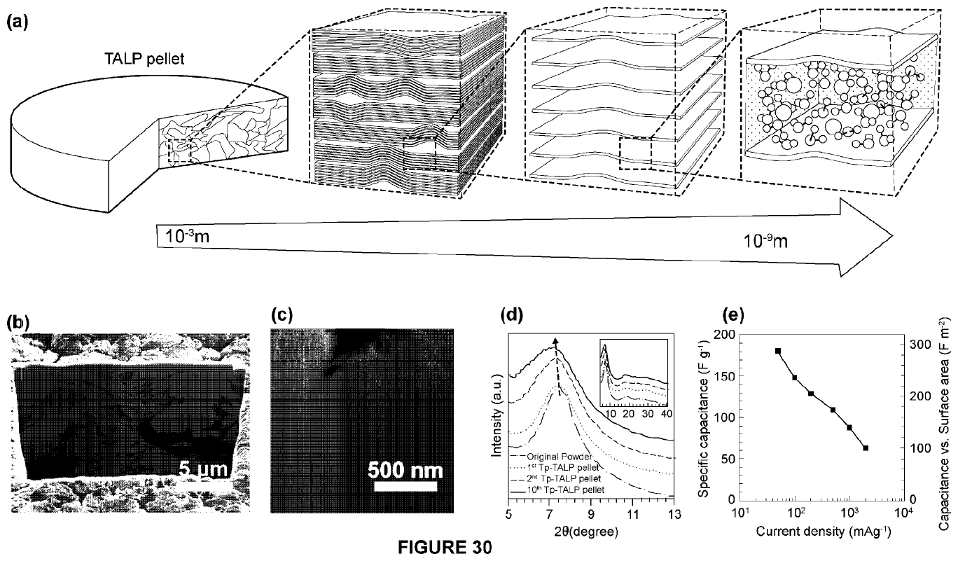

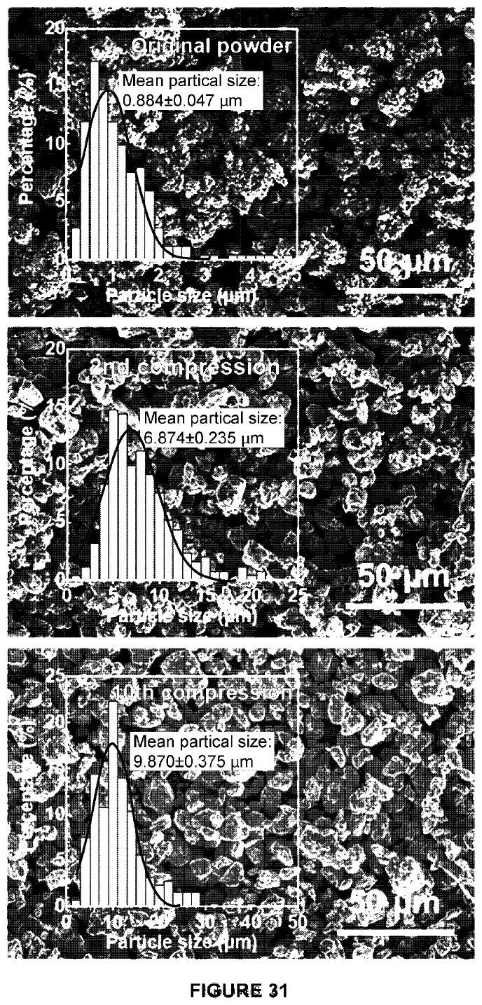

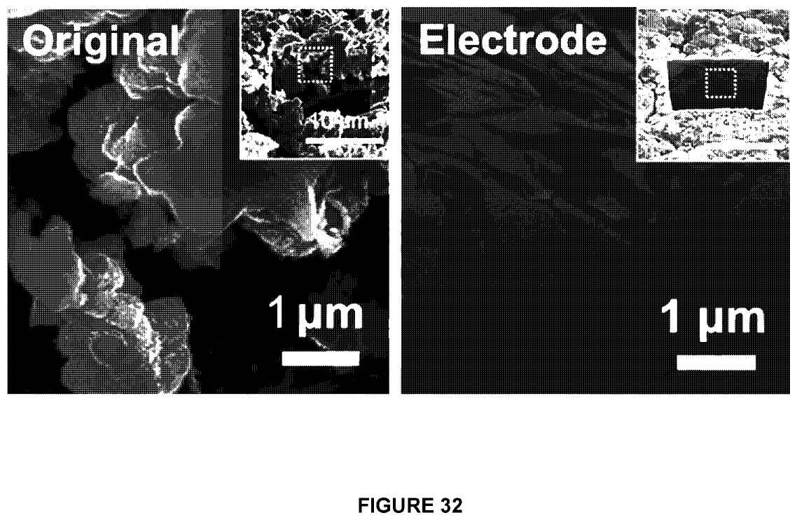

TALP is built from orderly-stacked organic-inorganic hybrid crystalline consisting of hydrogen-bonded pernigraniline molecular chains and tungstic acid. Therefore, both the interlayer and in-plane bonding are quite weak, which makes the particle soft and ductile. Through a milder mechanical tableting pressing process (0.8 GPa), TALP powder forms a high-density compact pellet (up to 1.85 g cm⁻³, FIG. 29). We noticed there is a series of structural variations at micrometer-, nanometer- and sub-nanometer-scales occurring during the mechanical process as seen in FIG. 30a. It is noteworthy that due to structural anisotropy of TALP, the effect of mechanical pressure on particle depends on two factors: relative location and orientation of the particle. Thus, to intensify the effect of a pressing process, a grinding and re-pressing procedure was applied to make single particle pressed in different directions. Cross section image of a TALP pellet in shown in FIG. 30b and FIG. 31 and indicates significant particle deformation which results in a dense chunk. In FIG. 31, the average particle size of the original particle, particle after twice compression, and particle after ten-times compression are 0.844±0.047 μm, 6.874±0.235 μm and 9.87±0.375 μm, respectively. Meanwhile, particle size increase caused by fusion was also detected, as shown in FIG. 32. At the micrometer-scale, TALP particle deforms and fills the interparticle gap, forming a dense chunk. At the nanoscale, the nanoflakes consisting of TALP 2D crystalline are wrinkled and form some mesoscopic tunnels in previous non-porous particles, as shown in FIG. 30c. At the sub-nanometer-scale, the interlayer space between 2D TALP crystalline is extended. Similar to some soft materials, the structural variations occurring on TALP can be attributed to mechanical effects, shear and uniaxial compression. Shear causes relative slide of 2D crystalline leading to particle deformation and fusion, and the uniaxial compression results in wrinkled flake. Besides, we also noticed that a subtle interlayer space expansion of TALP occurs during tableting pressing and accumulates with increasing pressing number of times (FIG. 30d). However, the interlayer space expansion has no effect on charge storage mechanism of intercalation capacitance, with a tableting pressed TALP (Tp-TALP) pellet still exhibits high specific capacitance under condition of low specific surface area (0.524 m² g-1, FIG. 30e). Given both shear and uniaxial compression can weaken interlayer bonding, the interlayer space expansion can be considered as a result of two-effects synergy.

2. Charge Storage Mechanism of TALP

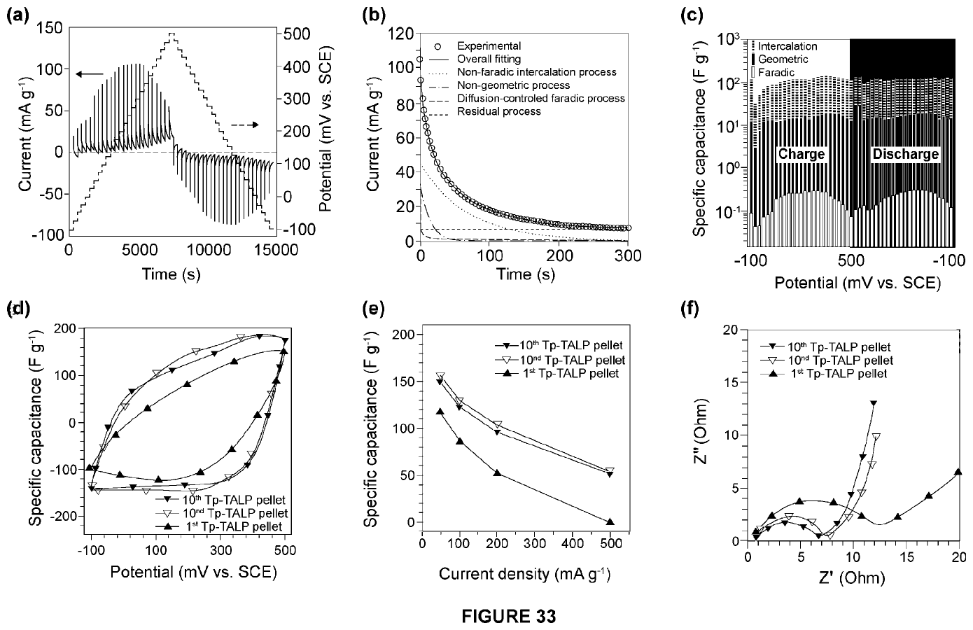

To investigate how structural variation effects performance, we applied step potential electrochemical spectroscopy (SPECS) on a TALP pellet (pure TALP electrode without conducting additives) to gain a comprehensive understanding of charge storage mechanism of TALP. A whole SPECS cycle (starting from 0V vs. SCE and potential step of 25 mV) is constituted of spike current arising from double-layer capacitive behaviour, which means the capacitance of TALP is majorly attributed to a non-faradic process. However, some spike current does not decay to zero, which indicates some kinetics-limited sustaining redox reaction is occurring on surface of electrode. Given the uncertainty brought by deconvolution of capacitance (double layer) and pseudocapacitance (redox reaction), we mathematically isolated the contribution to the total current from each individual electrochemical process, including non-faradic intercalation process, non-faradic geometric process and diffusion controlled faradic process, at different potentials. Taking the current fitting curve at potential of 350 mV (vs. SCE) as an example, non-faradic intercalation process generates most of the total current and non-faradic geometric process offers fast decaying smaller current in the first 50 seconds, while the contribution from diffusion-controlled faradic process is negligible (FIG. 33b). Expanding the view to s whole range of potential cycled, capacitance of TALP arises majorly from non-faradic intercalation process (FIG. 33c). Thus, it is evidential that TALP possesses a charge storage mechanism of intercalation capacitance. This mechanism makes TALP, a low specific surface area material, exhibit ultra-high double layer capacitance.

Because the charge storage location of intercalation capacitance is interlayer space, interlayer space expansion can offer extra charge storage capacity to TALP. Therefore, several cycles of a tableting processing process makes TALP pellets offer higher specific capacitance than the pellets directly made from original powder (FIG. 33d). An enlarged interlayer space is advantageous for fast ion diffusion. Besides, the mesoscopic tunnel built from flake wrinkle greatly accelerates ion diffusion process in TALP particle. Based on the above two factors, tableting pressing process can reduce ion diffusion resistance of TALP significantly (FIG. 33e), which is beneficial to increase power density of the electrode (FIG. 330. However, other pressing process can be sued in place of tablet pressing to form an electrode, capacitor or similar electrical device.

3. Performance of High Mass Loading Tablet-Pressed (Tp)-TALP Electrode

It is known that higher areal mass loading of active material theoretically leads to a high whole device performance and in a commercialized device the mass loading is usually higher than 10 mg cm⁻². However, high mass loading leads to performance reduction of active materials and whole devices because both electron and ionic conductivity of electrode decline along with the increase of electrode thickness. Besides, a density of material is also a consideration, especially for some miniature device. Unfortunately, high density and good ionic conductivity is usually a pair of contradictions.

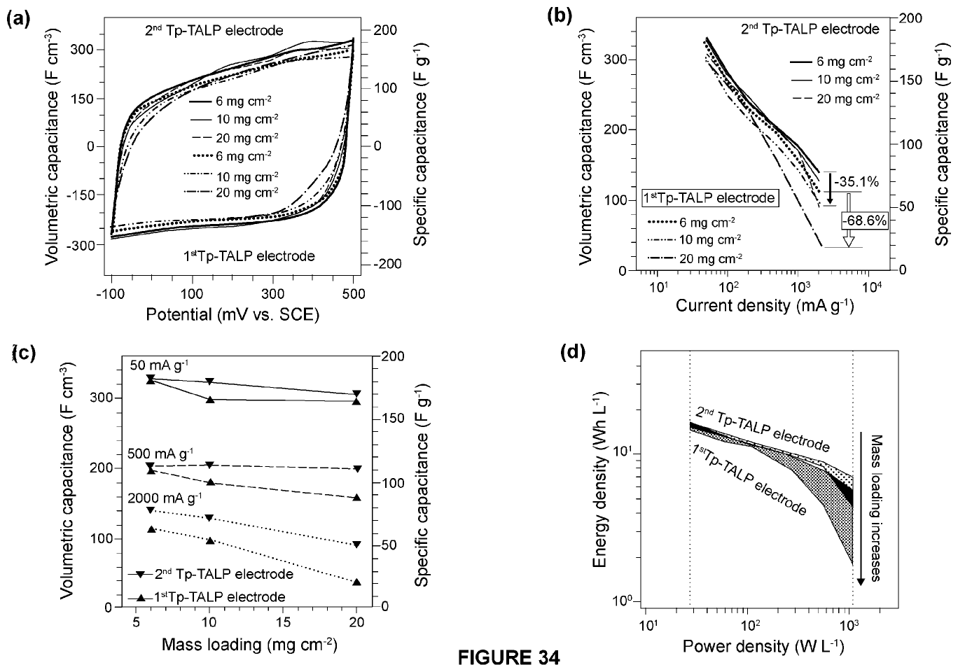

To evaluate performance of TALP, we carried out a series of electrochemical test on binder-free Tp-TALP electrodes (TALP:carbon black=9:1 by mass, density≥1.8 cm⁻³) with different mass loadings. CV curves of a TALP electrode are similar to a pellet but closer to rectangle, which means they possess intercalation capacitance and better conductivity (FIG. 34a). It is obvious that increasing mass loading leads significant specific capacitance decline on 1^{st} Tp-TALP electrode but 2^{nd} Tp-TALP electrode is scarcely affected. Although different mass loading leads to performance difference, there is little difference of electrochemical behaviour and charge storage mechanism. In the case of small current, 1^{st} Tp-TALP electrodes and 2^{nd} Tp-TALP electrodes with different mass loading demonstrate similar specific capacitance ranging from 182 to 165 F g⁻¹ through GCD methods (FIG. 34b). Current density excess of 200 mA g⁻¹ causes considerable performance decline of high-mass-loading 1^{st} Tp-TALP electrode (20 mg cm⁻²). For 2^{nd} Tp-TALP electrode with same mass loading, by contrast, the performance remains the same until current density exceeds 1000 mA g⁻¹. Under a current of 2000 mA g⁻¹, specific capacitance of 1^{st} Tp-TALP electrode with high mass loading (20 mg cm⁻²) is 68.6% lower than the electrode with low mass loading (6 mg cm⁻¹). However, the difference between 2^{nd} Tp-TALP electrodes is only 35.1%. The specific capacitance comparison of Tp-TALP electrodes indicates that tableting pressing process (e.g. a compression process) can greatly reduce performance dependence on mass loading (thickness) of TALP electrodes (FIG. 34c and FIG. 34d). Given that the measured performance evolutions of TALP are consistent with the structural variations which results in ion diffusion process intensification, we can conclude that the tableting pressing process helps to boost power density of TALP electrode.

4. Performance of Asymmetric Tp-TALP∥HPGM Supercapacitor

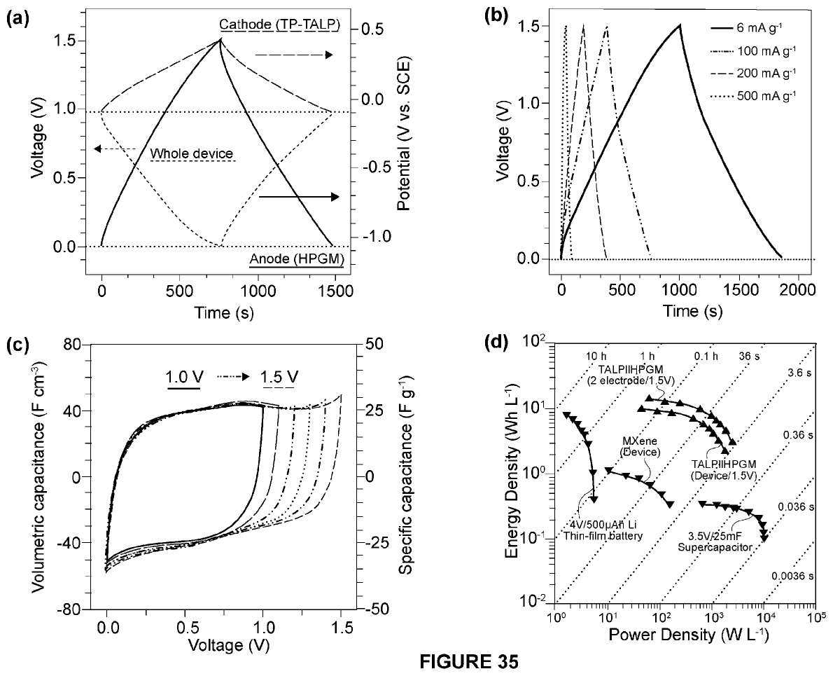

Asymmetric supercapacitors possess high energy density due to a wide operation voltage window covering both working potential range of cathode and anode materials. The power density of a whole asymmetric device depends on both power density of the cathode and anode. Currently, graphene-based electrode materials, especially foam graphene, feature high power density and mass-loadings-insensitive performance, which make them ideal anode materials for asymmetric supercapacitors with high mass loading. Given this, we designed and fabricated a device of a high mass loading asymmetric supercapacitor using a Tp-TALP cathode accompanied with high-density porous graphene macroform (HPGM) anode. This device works in aqueous electrolyte (1 M Na₂SO₄). Considering the potential range and the specific capacitance of TALP and HPGM, we applied a mass ratio of 2:1 to offer a voltage window of 1.5 V and the average density of active material including the cathode (10 mg cm⁻¹) and anode (5 mg cm⁻¹) is 1.6 g cm⁻³. The GCD profiles (FIG. 35a and FIG. 35b) of Tp-TALP∥HPGM supercapacitor show that the whole device voltage and the potential of electrodes vary along with the charging and discharging time linearly, indicating a capacitive behaviour. FIG. 35c demonstrates CV curves of the device in different voltage windows, ranging from 1.0 to 1.5 V. The quasi rectangular curves also indicate a typical capacitive electrochemical behaviour.

FIG. 35d shows a performance comparison among several typical EESs with different charge storage mechanisms. Benefitting from high density and high mass loading, Tp-TALP∥HPGM supercapacitor exhibits an outstanding volumetric energy storage performance. Energy density basing on a two-electrode calculation is up to 14.2 Wh L⁻¹ at power output of 60 W L⁻¹ (FIG. 35d). Furthermore, a high energy density of 10.1 Wh L⁻¹ can be achieved under a tenfold power density. With a thickness of the cathode, anode, current collectors and separator being 55 μm, 45 μm, 10 μm and 15 μm respectively, the performance decline of whole device is only 23.1% comparing to electrode performance, which is a considerable advantage for practical application. Besides, a Tp-TALP∥HPGM supercapacitor can still offer a capacitance retention of 87.6 after 5000 charge-discharge cycles under a high current density of 1000 mA g⁻¹, demonstrating a good cyclic stability.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1-44. (canceled)

45. An electrically conductive or semi-conductive lamellar structure comprising:
a plurality of sheets, wherein each sheet comprises nanochains, wherein at least some of the nanochains are electrically conductive or semi-conductive, and crosslinking agents connecting adjacent nanochains.

46. A lamellar structure according to claim 45, wherein the one of the nanochains and crosslinking agents act as Lewis bases and the other of the crosslinking agents and nanochains act as Lewis acids, and wherein each sheet is a Lewis adduct.

47. A lamellar structure according to claim 45, wherein the nanochains are polymer chains.

48. A lamellar structure according to claim 45, wherein the crosslinking agents comprise a metal or metal oxide.

49. A lamellar structure according to claim 48, wherein the crosslinking agents are tungstic acid and/or molybdic acid.

50. A lamellar structure according to claim 45, wherein a basal spacing between adjacent sheets is greater than 5 Å.

51. A lamellar structure according to claim 45, wherein the lamellar structure is able to electrochemically intercalate electrolytes between adjacent sheets.

52. A lamellar structure according to claim 45, wherein the lamellar structure is electrically conductive and comprises electrically conductive nanochains.

53. A lamellar structure according to claim 45, wherein the lamellar structure has a capacitance of greater than 200 F cm⁻³.

54. A lamellar structure according to claim 45, wherein the lamellar structure has a porosity of less than about 100 m²g⁻¹.

55. A lamellar structure according to claim 45, wherein the lamellar structure has a conductance of about 6 S cm⁻¹.

56. A method for preparing a lamellar structure, the method comprising:
mixing a polymer precursor comprising a moiety capable of acting as a Lewis base with a multivalent Lewis acid crosslinker; and
polymerising the polymer precursor to form a lamellar structure comprising polymer nanochains with adjacent polymer nanochains cross-linked by the multivalent Lewis acid crosslinker.

57. A method according to claim 56, further comprising the step of adjusting a pH of a mixture comprising the polymer precursor and multivalent Lewis acid crosslinker to be less than the pKa of the multivalent Lewis acid crosslinker.

58. A method according to claim 57, wherein the pH is adjusted by adjusting the pH of a mixture comprising the polymer precursor prior to the mixture comprising the polymer precursor being mixed with the multivalent Lewis acid crosslinker.

59. A method according to claim 56, wherein polymerisation and crosslinking occurs simultaneously.

60. A method according to claim 56, wherein the polymer precursor and the multivalent Lewis acid crosslinker are added together over a period of time.

61. A method according to claim 56, wherein the multivalent Lewis acid crosslinker comprises a divalent metal oxide salt.

62. A method according to claim 61, wherein the polymer precursor is capable of polymerising to form an electrically semi-conductive or conductive polymer.

63. A method according to claim 61, wherein a molar ratio of [polymer precursor]: [divalent metal oxide salt] is 2:1.

64. A method according to claim 56, wherein the polymerisation is initiated with an oxidising agent, and wherein the oxidising agent is mixed with the multivalent Lewis acid crosslinker prior to mixing the polymer precursor with the multivalent Lewis acid crosslinker.
